(19) United States
(12) Patent Application Publication
(10) Pub. No.: US 2020/0147927 A1
(43) Pub. Date: May 14, 2020

(54) SHEETLIKE COMPOSITE, ESPECIALLY FOR PRODUCTION OF DIMENSIONALLY STABLE FOOD AND DRINK PRODUCT CONTAINERS, HAVING A FIRST AND A FURTHER ADHESION PROMOTER LAYER EACH HAVING AN ACRYLATE CONTENT

(71) Applicant: S!G TECHNOLOGY AG, Neuhausen am Rheinfall (CH)

(72) Inventors: Roland Bothor, Aachen (DE); Daniel Heinze, Linnich (DE)

(21) Appl. No.: 16/631,080

(22) PCT Filed: Jul. 12, 2018
(86) PCT No.: PCT/EP2018/069025

§ 371 Date: Jan. 14, 2020

(30) Foreign Application Priority Data
Jul. 14, 2017 (DE) 10 2017 212 144.0

(51) Int. Cl. B32B 7/12; B32B 37/12; B65B 3/02; B65B 3/04; B65D 81/34; B65D 65/40; B32B 27/32; B32B 27/36; B32B 27/08; B32B 27/10; B32B 1/02

(52) U.S. Cl. CPC B32B 7/12; B32B 2307/7246; B65B 3/02; B65B 3/04; B65D 81/3446; B65D 65/40; B32B 27/32; B32B 27/36; B32B 27/08; B32B 27/10; B32B 1/02; B32B 2439/70; B32B 2439/62; B32B 2307/54; B32B 2307/7244; B32B 37/12

(57) ABSTRACT

The invention relates to a sheetlike composite comprising, as mutually superposed layers in a direction from an outer face of the sheetlike composite to an inner face of the sheetlike composite, a) a carrier layer, b) a first adhesion promoter layer having a first acrylate content, c) a barrier layer, d) a further adhesion promoter layer having a further acrylate content, and e) an inner polymer layer; wherein the first acrylate content and the further acrylate content are each in a range from 7% to 40% by weight, based on the weight of the respective adhesion promoter layer. The invention further relates to methods of producing a sheetlike composite, a container precursor and a closed container and to the aforementioned method products; to a container precursor and a closed container each including at least one sheetlike region of the sheetlike composite; to uses of the sheetlike composite for production of a food or drink product container and in a microwave oven; and to a use of an adhesion promoter composition A and of an adhesion promoter composition B for production of a sheetlike composite for a food or drink product container.

The present invention relates to a sheetlike composite comprising, as mutually superposed layers in a direction from an outer face of the sheetlike composite to an inner face of the sheetlike composite,
a) a carrier layer,
b) a first adhesion promoter layer having a first acrylate content,
c) a barrier layer,
d) a further adhesion promoter layer having a further acrylate content, and
e) an inner polymer layer;

wherein the first acrylate content and the further acrylate content are each in a range from 7% to 40% by weight, based on the weight of the respective adhesion promoter layer. The invention further relates to methods of producing a sheetlike composite, a container precursor and a closed container and to the aforementioned method products; to a container precursor and a closed container each including at least one sheetlike region of the sheetlike composite; to uses of the sheetlike composite for production of a food or drink product container and in a microwave oven; and to a use of an adhesion promoter composition A and of an adhesion promoter composition B for production of a sheetlike composite for a food or drink product container.

For some time, food and drink products, whether they be food and drink products for human consumption or else animal feed products, have been preserved by storing them either in a can or in a jar closed by a lid. In this case, the shelf life can be increased firstly by sterilizing the food or drink product and the container, here the jar or can, separately and to the greatest possible extent in each case, and then introducing the food or drink product into the container and closing the container. However, these measures for increasing the shelf life of food and drink products, which have been tried and tested over a long period, have a series of disadvantages, for example the need for another sterilization later on. Cans and jars, because of their essentially cylindrical shape, have the disadvantage that very dense and space-saving storage is not possible. Moreover, cans and jars have considerable intrinsic weight, which leads to increased energy expenditure in transport. In addition, production of glass, tinplate or aluminium, even when the raw materials used for this purpose are recycled, necessitates quite a high expenditure of energy. In the case of jars, an additional aggravating factor is elevated expenditure on transport. The jars are usually prefabricated in a glass factory and then have to be transported to the facility where the food and drink products are dispensed with the use of considerable transport volumes. Furthermore, jars and cans can be opened only with considerable expenditure of force or with the aid of tools and hence in a rather laborious manner. In the case of cans, there is a high risk of injury arising from sharp edges that occur on opening. In the case of jars, there are recurrent instances of broken glass getting into the food or drink product in the course of filling or opening of the filled jars, which in the worst case can lead to internal injuries when the food or drink product is consumed. In addition, both cans and jars have to be labelled for identification and promotion of the food or drink product contents. The jars and cans cannot readily be printed directly with information and promotional messages. In addition to the actual print, a substrate for the print, a paper or a suitable film, is thus needed, as is a securing means, i.e. an adhesive or a sealant.

Other packaging systems for storing food and drink products over a long period with minimum impairment are known from the prior art. These are containers produced from sheetlike composites—frequently also referred to as laminates. Sheetlike composites of this kind are frequently constructed from a thermoplastic polymer layer, a carrier layer usually consisting of cardboard or paper which imparts dimensional stability to the container, an adhesion promoter layer, a barrier layer and a further polymer layer, as disclosed inter alia in WO 90/09926 A2. Since the carrier layer imparts dimensional stability to the container manufactured from the laminate, these containers, by contrast with film bags, can be regarded as a further development of the aforementioned jars and cans.

At the same time, these laminate containers already have many advantages over the conventional jars and cans. Nevertheless, there are opportunities for improvement in the case of these packaging systems too. For instance, the barrier layer in the prior art typically consists of an aluminium foil having a thickness of several gm. Aluminium is a material which is comparatively energy- and resource-intensive to produce. Moreover, the aluminium foil makes it difficult to recycle the laminate after the use of the prior art container. Thus, there has for some time been a need, for reasons of environmental protection, for a laminate suitable for production of food and drink product containers which has a minimum amount of metal, especially a minimum amount of aluminium. Moreover, there has long been a need for microwaveable food and drink product containers. For this reason too, there is a need for a laminate suitable for production of food and drink product containers which has a minimum amount of metal, especially a minimum amount of aluminium. It is particularly desirable here to overcome the aforementioned disadvantages if at all possible without having to accept adverse effects on the shelf life of food or drink products stored in the containers or on the integrity of the containers. The prior art discloses laminates having an aluminium-free barrier layer. However, this barrier layer, after processing to give a container, frequently has inadequate barrier action against oxygen and/or against moisture and/or inadequate adhesion to adjoining layers of the laminate.

In general terms, it is an object of the present invention to at least partly overcome a disadvantage that arises from the prior art. It is a further object of the invention to provide a laminate of maximum environmental compatibility from which it is possible to produce a dimensionally stable food or drink product container for storing a food or drink product with maximum shelf life, especially under mechanical stress on the container, for example as a result of squeezing. For this purpose, the container preferably has a maximum bond strength of a seal seam, especially an ultrasound seal seam. Further preferably, containers made from the laminate less frequently show leaks. Additionally or alternatively, the aforementioned laminate is also suitable for use in a microwave oven. It is an additional or alternative object of the invention to provide a laminate for production of a dimensionally stable food or drink product container having particularly good processing properties in production of the food or drink product container from the laminate. In this context, preferably, a barrier effect of the laminate with respect to water vapour and oxygen is reduced as little as possible during processing of laminate to give the container. It is a further object of the invention to provide the aforementioned advantageous laminate with a minimum basis weight. This is found to be particularly advantageous especially in the case of transport of large amounts of food or drink product containers, since, as well as the space required, the weight of the containers also constitutes a limiting factor for transport capacities. Additionally or alternatively to the above, it is a further object of the invention to provide a laminate for production of dimensionally stable food or drink product containers which is producible with a production plant of reduced complexity. It is a further object of the invention to provide a dimensionally stable food or drink product containers made from the aforementioned advantageous laminate. It is a further object of the invention to provide a method of producing a dimensionally stable food or drink product container from the aforementioned advantageous laminate.

A contribution to the at least partial achievement of at least one, preferably more than one, of the above objects is made by the independent claims. The dependent claims provide preferred embodiments which contribute to the at least partial achievement of at least one of the objects.

A contribution to the achievement of at least one of the objects of the invention is made by an embodiment 1 of a sheetlike composite 1 comprising, as mutually superposed layers, in a direction from an outer face of the sheetlike composite to an inner face of the sheetlike composite,
a) a carrier layer,
b) a first adhesion promoter layer having a first acrylate content,
c) a barrier layer,
d) a further adhesion promoter layer having a further acrylate content, and
e) an inner polymer layer;

wherein the first acrylate content and the further acrylate content are each in a range from 7% to 40% by weight, preferably from 8% to 40% by weight, more preferably from 9% to 40% by weight, more preferably from 10% to 40% by weight, even more preferably from 11% to 40% by weight, even more preferably from 12% to 35% by weight, most preferably from 13% to 30% by weight, based in each case on the weight of the respective adhesion promoter layer. The first adhesion promoter layer and the further adhesion promoter layer are each preferably polymer layers.

In one embodiment 2 according to the invention, the sheetlike composite 1 is configured according to embodiment 1, wherein the first acrylate content and the further acrylate content differ from one another by not more than 10% by weight, preferably not more than 5% by weight, more preferably not more than 3% by weight, most preferably not more than 1% by weight.

In one embodiment 3 according to the invention, the sheetlike composite 1 is configured according to either of its preceding embodiments, wherein the first adhesion promoter layer has a first Vicat softening temperature and the further adhesion promoter layer has a further Vicat softening temperature, wherein the first Vicat softening temperature and the further Vicat softening temperature are each in a range from 20 to 120° C., preferably from 25 to 100° C., more preferably from 25 to 90° C., even more preferably from 25 to 80° C., most preferably from 30 to 60° C. Preferably, the first Vicat softening temperature and the further Vicat softening temperature differ from one another by not more than 20° C., preferably not more than 15° C., more preferably not more than 10° C.

In one embodiment 4 according to the invention, the sheetlike composite 1 is configured according to any of its preceding embodiments, wherein the first adhesion promoter layer includes an adhesion promoter polymer A, wherein the further adhesion promoter layer includes an adhesion promoter polymer B. In this case, the adhesion promoter polymer A and the adhesion promoter polymer B may be the same or different. Preferably, the adhesion promoter polymer A and the adhesion promoter polymer B are the same.

In one embodiment 5 according to the invention, the sheetlike composite 1 is configured according to embodiment 4, wherein the adhesion promoter polymer A is based on at least 3 mutually different monomers, wherein the adhesion promoter polymer B is based on at least 3 mutually different monomers. In this case, the adhesion promoter polymer A and the adhesion promoter polymer B are independently based on at least 3 mutually different monomers. In a preferred configuration of the sheetlike composite of the invention, the adhesion promoter polymer A is based at least one, preferably on at least 2, more preferably on at least 3, of the same monomers as the adhesion promoter polymer B. More preferably, the adhesion promoter polymer A and the adhesion promoter polymer B are the same.

In one embodiment 6 according to the invention, the sheetlike composite 1 is configured according to embodiment 4 or 5, wherein the adhesion promoter polymer A and the adhesion promoter polymer B are polyolefin-acrylate copolymers. In this case, the adhesion promoter polymer A and the adhesion promoter polymer B may be the same or different polyolefin-acrylate copolymers. The adhesion promoter polymer A and the adhesion promoter polymer B are preferably the same polyolefin-acrylate copolymer.

In one embodiment 7 according to the invention, the sheetlike composite 1 is configured according to embodiment 6, wherein the polyolefin in the adhesion promoter polymer A or the polyolefin in the adhesion promoter polymer B or each of them is based on ethylene.

In one embodiment 8 according to the invention, the sheetlike composite 1 is configured according to any of its embodiments 4 to 7, wherein the adhesion promoter polymer A or the adhesion promoter polymer B or each of them is a polyolefin-alkyl acrylate copolymer. The alkyl group selected is preferably a methyl, ethyl, propyl, i-propyl, butyl, i-butyl or a pentyl group. A particularly preferred polyolefin-alkyl acrylate copolymer is a polyolefin-ethyl acrylate copolymer. If the adhesion promoter polymer A and the adhesion promoter polymer B are polyolefin-alkyl acrylate copolymers, the adhesion promoter polymer A and the adhesion promoter polymer B may be the same or different polyolefin-alkyl acrylate copolymers. The adhesion promoter polymer A and the adhesion promoter polymer B here are preferably the same polyolefin-alkyl acrylate copolymer. Further preferably, the first adhesion promoter layer or the further adhesion promoter layer, or each of them, may have a mixture of two or more different polyolefin-alkyl acrylate copolymers. Likewise preferably, the polyolefin-alkyl acrylate copolymer may have two or more different alkyl groups in the acrylate function, for example a polyolefin-alkyl acrylate copolymer in which both, methyl acrylate units and ethyl acrylate units, occur in the same copolymer.

In one embodiment 9 according to the invention, the sheetlike composite 1 is configured according to any of its embodiments 4 to 8, wherein the adhesion promoter polymer A or the adhesion promoter polymer B or each of them is a grafted copolymer. Preferably, the polyolefin-acrylate copolymer has been grafted, i.e. is the same as the grafted copolymer. If the adhesion promoter polymer A and the adhesion promoter polymer B are grafted copolymers, these may be the same or different. The adhesion promoter polymer A and the adhesion promoter polymer B are preferably the same grafted copolymer.

In one embodiment 10 according to the invention, the sheetlike composite 1 is configured according to any of its embodiments 4 to 9, wherein the adhesion promoter polymer A or the adhesion promoter polymer B or each of them is a copolymer grafted with a diacid anhydride. A preferred diacid anhydride here is a maleic anhydride. If the adhesion promoter polymer A and the adhesion promoter polymer B are copolymers grafted with a diacid anhydride, these may be the same or different and are preferably the same.

In one embodiment 11 according to the invention, the sheetlike composite 1 is configured according to any of its preceding embodiments, wherein the first adhesion promoter layer adjoins the barrier layer on a side of the barrier layer facing the carrier layer, wherein the further adhesion promoter layer adjoins the barrier layer on a side of the barrier layer remote from the carrier layer.

In one embodiment 12 according to the invention, the sheetlike composite 1 is configured according to any of its preceding embodiments, wherein the barrier layer has an adhesion to each of the first adhesion promoter layer and the further adhesion promoter layer in a range from 1 to 10 N/15 mm, preferably from 3 to 10 N/15 mm, more preferably from 5 to 10 N/15 mm. In a further preferred embodiment, the barrier layer has an adhesion to each of the first adhesion promoter layer and the further adhesion promoter layer of at least 3 N/15 mm, more preferably of 5 N/15 mm.

In one embodiment 13 according to the invention, the sheetlike composite 1 is configured according to any of its preceding embodiments, wherein the barrier layer on a side facing the carrier layer consists of a different material from that of a side remote from the carrier layer.

In one embodiment 14 according to the invention, the sheetlike composite 1 is configured according to any of its preceding embodiments, wherein the barrier layer includes, as mutually superposed sublayers,
a. a barrier substrate layer, and
b. a barrier material layer;

wherein the barrier material layer has an average thickness in a range from 1 nm to 1 μm, preferably from 1 to 500 nm, more preferably from 1 to 300 nm, most preferably from 1 to 100 nm. Preferably, the barrier substrate layer has an average thickness in a range from 2 to 35 μm, preferably from 3 to 30 μm, more preferably from 4 to 25 μm, more preferably from 5 to 20 μm, most preferably from 8 to 15 μm.

In one embodiment 15 according to the invention, the sheetlike composite 1 is configured according to embodiment 14, wherein the barrier material layer overlays the barrier substrate layer on a side of the barrier substrate layer facing the inner face.

In one embodiment 16 according to the invention, the sheetlike composite 1 is configured according to embodiment 14 or 15, wherein the barrier layer additionally comprises a protective layer as a further sublayer, wherein the protective layer overlays the barrier material layer on a side of the barrier material layer remote from the barrier substrate layer. A useful protective layer is any layer that seems suitable to the person skilled in the art for the use according to the invention, especially for protection of the barrier material layer from mechanical influences such as the effect of a tool on the sheetlike composite. Preferably, the protective layer is plastically deformable at a temperature of 20° C. Additionally or alternatively, the protective layer preferably has a thickness in a range from 1 to 50 μm, preferably from 1 to 30 μm, more preferably from 1 to 30 μm. Additionally or alternatively to the aforementioned preferred properties, the protective layer preferably includes a polyvinyl alcohol (PVOH) or a siloxane compound or both. In this connection, the siloxane compound preferably has an empirical formula of the Si(OR)₄ form where R is an organic moiety.

In one embodiment 17 according to the invention, the sheetlike composite 1 is configured according to any of its preceding embodiments, wherein the barrier layer has an average thickness in a range from 2 to 35 μm, preferably from 5 to 30 μm, more preferably from 5 to 25 μm, most preferably from 5 to 20 μm.

In one embodiment 18 according to the invention, the sheetlike composite 1 is configured according to any of embodiments 14 to 17, wherein the barrier substrate layer adjoins the barrier material layer. Preferably, the barrier layer consists of the barrier substrate layer and the barrier material layer, or of the barrier substrate layer, the barrier material layer and the protective layer. Preferably, the barrier substrate layer is joined directly to the barrier material layer, preferably by intermolecular bonds or covalent bonds or both.

In one embodiment 19 according to the invention, the sheetlike composite 1 is configured according to any of embodiments 14 to 18, wherein the first adhesion promoter layer adjoins the barrier material layer.

In one embodiment 20 according to the invention, the sheetlike composite 1 is configured according to any of embodiments 16 to 19, wherein the protective layer adjoins the barrier material layer.

In one embodiment 21 according to the invention, the sheetlike composite 1 is configured according to any of embodiments 16 to 20, wherein the further adhesion promoter layer adjoins the protective layer.

In one embodiment 22 according to the invention, the sheetlike composite 1 is configured according to any of its preceding embodiments, wherein the barrier layer has an oxygen permeation rate in a range from 0.1 to 40 cm³/(m²·day·atm), preferably from 0.1 to 20 cm³/(m²·day·atm), more preferably from 0.1 to 10 cm³/(m²·day·atm), more preferably from 0.1 to 5 cm³/(m²·day·atm), more preferably from 0.1 to 3 cm³/(m²·day·atm), more preferably from 0.1 to 2 cm³/(m²·day·atm), most preferably from 0.1 to 1 cm³/(m²·day·atm).

In one embodiment 23 according to the invention, the sheetlike composite 1 is configured according to any of its preceding embodiments, wherein the barrier layer has a water vapour permeation rate in a range from 0.1 to 40 g/(m²·day), preferably from 0.1 to 20 g/(m²·day), more preferably from 0.1 to 10 g/(m²·day), more preferably from 0.1 to 5 g/(m²·day), more preferably from 0.1 to 3 g/(m²·day), more preferably from 0.1 to 2 g/(m²·day), most preferably from 0.1 to 1 g/(m²·day).

In one embodiment 24 according to the invention, the sheetlike composite 1 is configured according to any of its preceding embodiments, wherein the barrier layer has at least one of the following features:
A. a tensile strength in a range from 100 to 160 MPa, preferably from 110 to 150 MPa, more preferably from 120 to 145 MPa, most preferably from 125 to 140 MPa,
B. a tensile elongation in a range from 80% to 130%, preferably from 85% to 125%, more preferably from 90% to 120%, most preferably from 90% to 115%,
C. a modulus of elasticity in a range from 4000 to 5500 MPa, preferably from 4100 to 5300 MPa, more preferably from 4100 to 5100 MPa, more preferably from 4100 to 5000 MPa, more preferably from 4100 to 4900 MPa, more preferably from 4200 to 4800 MPa, most preferably from 4300 to 4750 MPa.

The above properties are each applicable preferably in a direction of extension of the barrier layer in a layer plane of the barrier layer. The layer plane here is preferably the plane in which the barrier layer extends sheetlike. A preferential direction of extension is a machine direction (MD) or a direction which is perpendicular to the machine direction in the layer plane of the barrier layer. In this context, the machine direction is preferably a direction of a first stretching operation on at least one sublayer of the barrier layer. The direction which is perpendicular to the machine direction is preferably a direction of a subsequent stretching operation on at least one sublayer of the barrier layer. The sublayer here is preferably the barrier substrate layer.

In one embodiment 25 according to the invention, the sheetlike composite 1 is configured according to any of its embodiments 14 to 24, wherein the barrier substrate layer comprises a polymer at a proportion of at least 50% by weight, preferably of at least 60% by weight, more preferably of at least 70% by weight, more preferably of at least 80% by weight, most preferably of at least 90% by weight, based in each case on the weight of the barrier substrate layer. A preferred polymer here is an oriented polymer. The oriented polymer has preferably been monoaxially oriented or biaxially oriented. A further preferred polymer is a thermoplastic polymer. Preferably, the barrier substrate layer consists of the polymer.

In one embodiment 26 according to the invention, the sheetlike composite 1 is configured according to its embodiment 25, wherein the polymer is selected from the group consisting of a polycondensate, a polyethylene, a polypropylene, a polyvinyl alcohol, or a combination of at least two of these. A preferred polypropylene has been oriented, especially longitudinally stretched (oPP) or biaxially stretched (BoPP). A preferred polycondensate is a polyester or polyamide (PA) or both. A preferred polyester is one selected from the group consisting of a polyethylene terephthalate (PET), a polylactide (PLA) or a combination of at least two of these. A preferred polyvinyl alcohol is a vinyl alcohol copolymer. A preferred vinyl alcohol copolymer is an ethylene-vinyl alcohol copolymer.

In one embodiment 27 according to the invention, the sheetlike composite 1 is configured according to any of embodiments 14 to 26, wherein the barrier material layer comprises a barrier material at a proportion of at least 50% by weight, preferably of at least 60% by weight, more preferably of at least 70% by weight, more preferably of at least 80% by weight, most preferably of at least 90% by weight, based in each case on the weight of the barrier material layer, wherein the barrier material is selected from the group consisting of an oxide, a metal, a silicon-containing compound and a polymer, or a combination of at least two of these. A preferred oxide is an oxide of one selected from the group consisting of one or more metals, one or more semimetals and one or more nonmetals, or a combination of at least two of these, for example of Al₂O₃ and SiO₂. A preferred oxide of a metal is one selected from the group consisting of an aluminium oxide, for example Al₂O₃; a magnesium oxide, for example MgO; a titanium oxide, for example TiO₂; a tin oxide, for example an indium tin oxide (ITO), Zn₂SnO₄, SnO, Sn₂O₃ and SnO₂; a zinc oxide, for example ZnO; and an indium oxide, for example an indium tin oxide (ITO), InO, In₂O₃ and InO₂, or a combination of at least two of these. A preferred oxide of a semimetal is a silicon oxide, for example SiO₂. A preferred metal is aluminium. A preferred silicon-containing compound is a silicon nitride, for example Si₃N₄, or an organosilicon compound. A preferred organosilicon compound is a siloxane. A polymer preferred as a barrier material is a vinyl polymer or a polyacrylic acid or both. A preferred vinyl polymer is a polyvinylidene chloride (PVdC) or a polyvinyl alcohol (PVOH) or both. Preferably, the barrier material layer consists of the barrier material.

In one embodiment 28 according to the invention, the sheetlike composite 1 is configured according to any of its preceding embodiments, wherein the barrier layer is characterized by an aluminium content of less than 50% by weight, preferably of less than 40% by weight, more preferably of less than 30% by weight, more preferably of less than 20% by weight, more preferably of less than 10% by weight, most preferably of less than 5% by weight, based in each case on the weight of the barrier layer. A preferred barrier layer does not contain any aluminium.

In one embodiment 29 according to the invention, the sheetlike composite 1 is configured according to any of its preceding embodiments, wherein the barrier layer is characterized by a metal content of less than 50% by weight, preferably of less than 40% by weight, more preferably of less than 30% by weight, more preferably of less than 20% by weight, more preferably of less than 10% by weight, most preferably of less than 5% by weight, based in each case on the weight of the barrier layer. A preferred barrier layer does not contain any metal.

In one embodiment 30 according to the invention, the sheetlike composite 1 is configured according to any of its preceding embodiments, wherein the sheetlike composite is characterized by an aluminium content of less than 10% by weight, more preferably of less than 8% by weight, most preferably of less than 5% by weight, based in each case on the weight of the sheetlike composite. A preferred sheetlike composite does not contain any aluminium.

In one embodiment 31 according to the invention, the sheetlike composite 1 is configured according to any of its preceding embodiments, wherein the sheetlike composite is characterized by a metal content of less than 10% by weight, more preferably of less than 8% by weight, most preferably of less than 5% by weight, based in each case on the weight of the sheetlike composite. A preferred sheetlike composite does not contain any metal.

In one embodiment 32 according to the invention, the sheetlike composite 1 is configured according to any of its preceding embodiments, wherein the further adhesion promoter layer has an average thickness in a range from 1 to 20 gm, more preferably from 1 to 15 μm, more preferably from 1 to 10 μm, most preferably from 2 to 6 μm.

In one embodiment 33 according to the invention, the sheetlike composite 1 is configured according to any of its preceding embodiments, wherein the first adhesion promoter layer has an average thickness in a range from 1 to 20 μm, more preferably from 1 to 15 μm, more preferably from 1 to 10 μm, most preferably from 2 to 6 μm. In a further preferred embodiment of the sheetlike composite 1, the first adhesion promoter layer has a first average thickness and the further adhesion promoter layer has a further average thickness, where the first average thickness differs from the further average thickness preferably by not more than 3 μm, more preferably by not more than 2 μm, even more preferably not more than 1 μm, most preferably not more than 0.5 μm.

In one embodiment 34 according to the invention, sheetlike composite 1 is configured according to any of its preceding embodiments, wherein the sheetlike composite further includes an outer polymer layer, wherein the outer polymer layer overlays the carrier layer on a side of the carrier layer facing the outer face of the sheetlike composite. The outer polymer layer preferably includes a polyethylene or a polypropylene or both. Further preferably, the outer polymer layer includes the polyethylene or polypropylene or both together to an extent of at least 60% by weight, more preferably to an extent of at least 70% by weight, even more preferably to an extent of at least 80% by weight, most preferably to an extent of at least 90% by weight, based in each case on the weight of the outer polymer layer. A preferred polyethylene here is an LDPE. Accordingly, the outer polymer layer preferably includes an LDPE to an extent of at least 50% by weight, preferably to an extent of at least 60% by weight, more preferably to an extent of at least 70% by weight, still more preferably to an extent of at least 80% by weight, most preferably to an extent of at least 90% by weight, based in each case on the weight of the outer polymer layer.

In one embodiment 35 according to the invention, the sheetlike composite 1 is configured according to any of its preceding embodiments, wherein the sheetlike composite includes a polymer interlayer between the carrier layer and the first adhesion promoter layer. A preferred polymer interlayer includes a polyethylene or a polypropylene or both. In this context, a particularly preferred polyethylene is an LDPE. Preferably, the polymer interlayer includes the polyethylene or the polypropylene or both together at a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. Additionally or alternatively, the polymer interlayer preferably includes an HDPE, preferably at a proportion of at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. In this context, the polymer interlayer includes the aforementioned polymers preferably in a polymer blend. The polymer interlayer preferably has a thickness in a range from 10 to 30 μm, more preferably of 12 to 28 μm. Preferably, the polymer interlayer adjoins a layer surface of the further adhesion promoter layer facing the outer face of the sheetlike composite. Additionally or alternatively, the polymer interlayer preferably adjoins the carrier layer.

In one embodiment 36 according to the invention, the sheetlike composite 1 is configured according to any of the preceding embodiments, wherein the carrier layer is overlaid on a side of the carrier layer remote from the barrier layer with a colour application, preferably a decoration. Preferably, the outer polymer layer is overlaid with the colour application on a side remote from the carrier layer. Preferably, the colour application includes at least one colourant, more preferably at least 2, more preferably at least 3, more preferably at least 4, even more preferably at least 5 and most preferably at least 6 colourants. In a further preferred embodiment, the colour application is between the carrier layer and the outer polymer layer.

In one embodiment 37 according to the invention, the sheetlike composite 1 is configured according to any of its preceding embodiments, wherein the carrier layer has at least one hole, wherein the hole is covered at least by the barrier layer and the inner polymer layer as holecovering layers. Preferably, the hole is further covered by one selected from the group consisting of the outer polymer layer, the polymer interlayer, the first adhesion promoter layer and the further adhesion promoter layer, or a combination of at least two of these. Layers covering the hole are referred to herein as hole-covering layers. If at least 2 hole-covering layers are present, the hole-covering layers in the hole preferably form a layer sequence of layers joined to one another in the hole.

In one embodiment 38 according to the invention, the sheetlike composite 1 is configured according to any of its preceding embodiments, wherein the carrier layer includes, preferably consists of, one selected from the group consisting of cardboard, paperboard and paper, or a combination of at least two of these.

In one embodiment 39 according to the invention, the sheetlike composite 1 is configured according to any of its preceding embodiments, wherein the sheetlike composite includes a linear recess on the outer face. A preferred linear recess has a length of at least 1 cm, preferably of at least 2 cm, more preferably of at least 10 cm. A particularly preferred linear recess extends from a first edge of the sheetlike composite to a further edge, preferably opposite the first edge, of the sheetlike composite. A further preferred linear recess is a linear displacement of material. A preferred linear displacement of material is a groove.

A contribution to the achievement of at least one of the objects of the invention is made by an embodiment 1 of a method 1 comprising, as method steps,
a) providing a sheetlike composite precursor comprising a carrier layer;
b) overlaying the carrier layer on one side of the carrier layer in the following sequence proceeding from the carrier layer with
   i) an adhesion promoter composition A having a first acrylate content, and
   ii) a barrier layer; and
c) overlaying the barrier layer on a side remote from the carrier layer in the following sequence proceeding from the barrier layer with
   i) an adhesion promoter composition B having a further acrylate content, and
   ii) an inner polymer layer;

wherein the first acrylate content and the further acrylate content are each in a range from 7% to 40% by weight, preferably from 8% to 40% by weight, more preferably from 9% to 40% by weight, more preferably from 10% to 40% by weight, even more preferably from 11% to 40% by weight, even more preferably from 12% to 35% by weight, most preferably from 13% to 30% by weight, based in each case on the weight of the respective adhesion promoter composition.

The adhesion promoter composition A and the adhesion promoter composition B are preferably each polymer compositions. The adhesion promoter composition A or the adhesion promoter composition B or both preferably have a melt flow index (190° C./2.16 kg, according to ASTM D1238) in a range from 3 to 12 g/10 min, more preferably from 5 to 10 g/10 min, most preferably from 6 to 9 g/10 min. Further preferably, the adhesion promoter composition A or the adhesion promoter composition B or both have a density according to ASTM D792 in a range from 0.8900 to 0.980 g/cm³, more preferably from 0.900 to 0.950 g/cm³, most preferably from 0.910 to 0.930 g/cm³. The method 1 is preferably a method of producing a sheetlike composite. This sheetlike composite is preferably configured according to any of the embodiments of the sheetlike composite 1 of the invention. Preferably, the barrier layer is configured according to one embodiment of the sheetlike composite 1. The overlaying in method step b) is preferably effected in the form of a lamination. Further preferably, the first adhesion promoter layer of the sheetlike composite 1 is obtainable from the adhesion promoter composition A. Alternatively or additionally, the further adhesion promoter layer of the sheetlike composite 1 is preferably obtainable from the adhesion promoter composition B. The inner polymer layer is preferably configured according to any of the embodiments of the sheetlike composite 1 of the invention. Preferably, the overlaying with the inner polymer layer comprises overlaying with an inner polymer composition from which the inner polymer layer is obtained. Preferably, in method step c), the adhesion promoter composition B is contacted with the inner polymer layer or with an inner polymer composition from which the inner polymer layer is obtained. Preferably, in method step c), the overlaying is effected in the form of a coextrusion of the adhesion promoter layer B and an inner polymer composition from which the inner polymer layer is obtained.

In one embodiment 2 according to the invention, the method 1 is configured according to its embodiment 1, wherein the first acrylate content and the further acrylate content differ from one another by not more than 10% by weight, preferably not more than 5% by weight, more preferably not more than 3% by weight, most preferably not more than 1% by weight.

In one embodiment 3 according to the invention, the method 1 is configured according to its embodiment 1 or 2, wherein the adhesion promoter composition A has a first Vicat softening temperature and the adhesion promoter composition B has a further Vicat softening temperature, wherein the first Vicat softening temperature and the further Vicat softening temperature are each in a range from 20 to 120° C., preferably from 25 to 100° C., more preferably from 25 to 90° C., even more preferably from 25 to 80° C., most preferably from 30 to 60° C. Preferably, the first Vicat softening temperature and the further Vicat softening temperature differ from one another by not more than 20° C., preferably not more than 15° C., more preferably not more than 10° C.

In one embodiment 4 according to the invention, the method 1 is configured according to any of its embodiments 1 to 3, wherein the adhesion promoter composition A includes an adhesion promoter polymer A, wherein the adhesion promoter composition B includes an adhesion promoter polymer B. In this case, the adhesion promoter polymer A and the adhesion promoter polymer B may be the same or different. Preferably, the adhesion promoter polymer A and the adhesion promoter polymer B are the same. Preferably, the adhesion promoter composition A consists of the adhesion promoter polymer A. Additionally or alternatively, the adhesion promoter composition B preferably consists of the adhesion promoter polymer B. Further preferably, the adhesion promoter polymer A is configured according to any of the embodiments of the sheetlike composite 1 of the invention. Additionally or alternatively, the adhesion promoter polymer B is preferably configured according to any of the embodiments of the sheetlike composite 1 of the invention. In a preferred embodiment, the adhesion promoter composition A includes the adhesion promoter polymer A at a proportion in a range from 30% to 100% by weight, preferably from 40% to 100% by weight, more preferably from 50% to 100% by weight, more preferably from 60% to 100% by weight, more preferably from 70% to 100% by weight, more preferably from 80% to 100% by weight, most preferably from 90% to 100% by weight, based in each case on the weight of the adhesion promoter composition A. Additionally or alternatively, the adhesion promoter composition B includes the adhesion promoter polymer B at a proportion in a range from 30% to 100% by weight, preferably from 40% to 100% by weight, more preferably from 50% to 100% by weight, more preferably from 60% to 100% by weight, more preferably from 70% to 100% by weight, more preferably from 80% to 100% by weight, most preferably from 90% to 100% by weight, based in each case on the weight of the adhesion promoter composition B.

In one embodiment 5 according to the invention, the method 1 is configured according to its embodiment 4, wherein the adhesion promoter polymer A is based on at least 3 mutually different monomers, wherein the adhesion promoter polymer B is based on at least 3 mutually different monomers. In a preferred configuration of the sheetlike composite of the invention, the adhesion promoter polymer A is based on at least one, preferably on at least 2, more preferably on at least 3, of the same monomers as the adhesion promoter polymer B. More preferably, the adhesion promoter polymer A and the adhesion promoter polymer B are the same.

In one embodiment 6 according to the invention, the method 1 is configured according to its embodiment 4 or 5, wherein the adhesion promoter polymer A and the adhesion promoter polymer B are polyolefin-acrylate copolymers. In this case, the adhesion promoter polymer A and the adhesion promoter polymer B may be the same or different polyolefin-acrylate copolymers. The adhesion promoter polymer A and the adhesion promoter polymer B are preferably the same polyolefin-acrylate copolymer.

In one embodiment 7 according to the invention, the method 1 is configured according to its embodiment 6, wherein the polyolefin in the adhesion promoter polymer A or the polyolefin in the adhesion promoter polymer B or each of them is based on ethylene.

In one embodiment 8 according to the invention, the method 1 is configured according to any of its embodiments 4 to 7, wherein the adhesion promoter polymer A or the adhesion promoter polymer B or each of them is a polyolefin-alkyl acrylate copolymer. The alkyl group selected is preferably a methyl, ethyl, propyl, i-propyl, butyl, i-butyl or a pentyl group. A particularly preferred polyolefin-alkyl acrylate copolymer is a polyolefin-ethyl acrylate copolymer. If the adhesion promoter polymer A and the adhesion promoter polymer B are polyolefin-alkyl acrylate copolymers, the adhesion promoter polymer A and the adhesion promoter polymer B may be the same or different polyolefin-alkyl acrylate copolymers. The adhesion promoter polymer A and the adhesion promoter polymer B here are preferably the same polyolefin-alkyl acrylate copolymer. Further preferably, the adhesion promoter composition A or the adhesion promoter composition B or each of them may have a mixture of two or more different polyolefin-alkyl acrylate copolymers. Likewise preferably, the polyolefin-alkyl acrylate copolymer may have two or more different alkyl groups in the acrylate function, for example a polyolefin-alkyl acrylate copolymer in which both, methyl acrylate units and ethyl acrylate units, occur in the same copolymer.

In one embodiment 9 according to the invention, the method 1 is configured according to any of its embodiments 4 to 8, wherein the adhesion promoter polymer A or the adhesion promoter polymer B or each of them is a grafted copolymer. Preferably, the polyolefin-acrylate copolymer has been grafted, i.e. is the same as the grafted copolymer. If the adhesion promoter polymer A and the adhesion promoter polymer B are grafted copolymers, these may be the same or different. The adhesion promoter polymer A and the adhesion promoter polymer B are preferably the same grafted copolymer.

In one embodiment 10 according to the invention, the method 1 is configured according to its embodiment 9, wherein the adhesion promoter polymer A or the adhesion promoter polymer B or each of them is a copolymer grafted with a diacid anhydride. A preferred diacid anhydride here is a maleic anhydride. If the adhesion promoter polymer A and the adhesion promoter polymer B are copolymers grafted with a diacid anhydride, these may be the same or different and are preferably the same.

In one embodiment 11 according to the invention, the method 1 is configured according to any of its embodiments 1 to 10, wherein, in the method step b), the adhesion promoter composition A is contacted with the barrier layer on a side of the barrier layer facing the carrier layer. Preferably, the adhesion promoter composition A is contacted here with the barrier substrate layer of the barrier layer. A preferred contacting operation is a coating.

In one embodiment 12 according to the invention, the method 1 is configured according to any of its embodiments 1 to 11, wherein, in the method step c), the adhesion promoter composition B is contacted with the barrier layer on a side of the barrier layer remote from carrier layer. Preferably, the adhesion promoter composition B is contacted here with the protective layer of the barrier layer. A preferred contacting operation is a coating.

In one embodiment 13 according to the invention, the method 1 is configured according to any of its embodiments 1 to 12, wherein the barrier layer is provided in the method step a) as a film, wherein the film on a side facing the carrier layer consists of a different material than on a side remote from the carrier layer. The film is preferably in multilayer form. For this purpose, the film preferably includes at least 2, preferably exactly 2 or exactly 3, mutually superposed sublayers.

In one embodiment 14 according to the invention, the method 1 is configured according to any of its embodiments 1 to 13, wherein, in method step b), the adhesion promoter composition A is overlaid at a first basis weight and, in method step c), the adhesion promoter composition B is overlaid at a further basis weight, where the further basis weight is more than the first basis weight. Preferably, the first basis weight is in a ratio to the further basis weight in a range from 1:10 to 9:10, more preferably from 1:5 to 4:5, most preferably from 2:5 to 4:5.

In one embodiment 15 according to the invention, the method 1 is configured according to any of its embodiments 1 to 14, wherein, in method step b), the adhesion promoter composition A is overlaid at a basis weight in a range from 0.5 to 10 g/m², preferably from 1 to 6 g/m², more preferably from 2 to 4 g/m².

In one embodiment 16 according to the invention, the method 1 is configured according to any of its embodiments 1 to 15, wherein, in the method step c), the adhesion promoter composition B is overlaid at a basis weight in a range from 1 to 12 g/m², preferably from 2 to 10 g/m², more preferably from 3 to 8 g/m², most preferably from 4 to 6 g/m².

In one embodiment 17 according to the invention, the method 1 is configured according to any of its embodiments 1 to 16, wherein, in the method step b), a polymer interlayer is introduced between the carrier layer and the adhesion promoter composition A. Preferably, the introducing of the polymer interlayer comprises introducing of an intermediate polymer composition from which the polymer interlayer is obtained. Preferably, in method step b), the adhesion promoter composition A is contacted with the polymer interlayer or with an intermediate polymer composition from which the polymer interlayer is obtained. In a preferred embodiment, in the method step b), the adhesion promoter composition A and an intermediate polymer composition from which the polymer interlayer is obtained are overlaid via coextrusion. The polymer interlayer is preferably configured according to any of the embodiments of the sheetlike composite 1 of the invention. The polymer interlayer or an intermediate polymer composition from which the polymer interlayer is obtained is preferably overlaid at a basis weight in a range from 10 to 30 g/m², more preferably from 13 to 25 g/m², most preferably 16 to 20 g/m².

In one embodiment 18 according to the invention, the method 1 is configured according to any of its embodiments 1 to 17, wherein the overlaying in the method step b) is effected on a first side of the carrier layer; wherein the providing in the method step a) comprises an overlaying of the carrier layer on a further side of the carrier layer, which is opposite to the first side, with an outer polymer layer. Preferably, the overlaying with the outer polymer layer comprises an overlaying with an outer polymer composition from which the outer polymer layer is obtained. The outer polymer layer is preferably configured according to any of the embodiments of the sheetlike composite 1 of the invention. The outer polymer layer or an outer polymer composition from which the outer polymer layer is obtained is preferably overlaid at a basis weight in a range from 5 to 25 g/m², more preferably from 10 to 20 g/m², most preferably 12 to 16 g/m².

In one embodiment 19 according to the invention, the method 1 is configured according to any of its embodiments 1 to 18, wherein the overlaying in the method step b) is effected on a first side of the carrier layer; wherein the method further includes an overlaying of the carrier layer on a further side of the carrier layer, which is opposite to the first side, with a colour application. The overlaying with the colour application is preferably effected prior to the method step b) or after the method step c). A preferred colour application is a decoration. The overlaying with the colour application is preferably effected prior to the overlaying with the outer polymer layer or thereafter. Accordingly, the colour application is preferably overlaid onto a side of the outer polymer layer remote from the carrier layer, or the outer polymer layer is overlaid onto a side of the colour application remote from the carrier layer. Preferably, the colour application is applied to, preferably printed onto, the outer polymer layer or to the carrier layer. More preferably, the outer polymer layer is overlaid with the colour application on a side remote from the carrier layer. Preferably, the colour application includes at least one colourant, more preferably at least 2, more preferably at least 3, more preferably at least 4, even more preferably at least 5 and most preferably at least 6 colourants. More preferably, the colour application consists of one or more printing inks. In a preferred embodiment, the overlaying with the colour application is effected in the method step a). In a further preferred embodiment, the overlaying with the colour application is effected in an additional method step d).

In one embodiment 20 according to the invention, the method 1 is configured according to any of its embodiments 1 to 19, wherein the carrier layer in the method step a) includes at least one hole, wherein the at least one hole is covered in the method step b) at least by the barrier layer. Preferably, the hole is additionally covered in method step b) by the adhesion promoter composition A. Further, the hole is preferably additionally or alternatively covered in the method step c) at least by the inner polymer layer, preferably additionally by the adhesion promoter composition B. Moreover, the hole is preferably additionally or alternatively covered in the method step b) by the polymer interlayer. In the method step a), the hole is preferably additionally or alternatively covered with the outer polymer layer.

In one embodiment 21 according to the invention, the method 1 is configured according to any of its embodiments 1 to 20, wherein the overlaying in the method step b) is effected on a first side of the carrier layer; wherein the method includes, prior to the method step b) or after the method step c), a creating of a linear recess on a further side of the carrier layer, which is opposite to the first side. A preferred way of creating a linear recess is grooving. The grooving is preferably effected by the action of a grooving tool on the carrier layer. In a preferred embodiment, the linear recess is created in the method step a), more preferably after the overlaying with the colour application or prior to the overlaying with the outer polymer layer or both. In a further preferred embodiment, the linear recess is created in an additional method step e).

In one embodiment 22 according to the invention, the method 1 is configured according to any of its embodiments 1 to 21, wherein, in the method, a sheetlike composite is obtained from the sheetlike composite precursor, wherein the method includes cutting the sheetlike composite to size to give a blank for production of a single closed container. Preferably, the cutting-to-size is effected after the method step c). In a further preferred configuration, the cutting-to-size is effected in an additional method step f).

In one embodiment 23 according to the invention, the method 1 is configured according to any of its embodiments 1 to 22, wherein the method additionally includes, prior to the method step b), an adjusting of a surface tension of at least part of a surface of the barrier layer that, in the method step b), faces the adhesion promoter composition A to a value in a range from 38·10⁻³ N/m to 70·10⁻³ N/m, preferably from 40·10⁻³ N/m to 65·10⁻³ N/m, more preferably from 45·10⁻³ N/m to 62·10⁻³ N/m, most preferably from 50·10⁻³ N/m to 62·10⁻³ N/m. Preferably, the surface tension of the at least part of the surface of the barrier layer, preferably a surface of the barrier substrate layer, is increased. The adjustment is preferably effected by a surface treatment. A preferred surface treatment is one selected from the group consisting of a plasma treatment, a corona treatment and a flame treatment, or a combination of at least two of these. Further preferably, the aforementioned surface treatment is effected, more preferably in the case of the plasma treatment, in a vacuum.

In one embodiment 24 according to the invention, the method 1 is configured according to any of its embodiments 1 to 23, wherein the method additionally includes, prior to the method step c), an adjusting of a surface tension of at least part of a surface of the barrier layer on the side of the barrier layer which, in the method step c), is remote from the carrier layer to a value in a range from 38·10⁻³ N/m to 70·10⁻³ N/m, preferably from 40·10⁻³ N/m to 65·10⁻³ N/m, more preferably from 45·10⁻³ N/m to 62·10⁻³ N/m, most preferably from 50·10⁻³ N/m to 62·10⁻³ N/m. Preferably, the surface tension of the at least part of the surface of the barrier layer, preferably a surface of the barrier material layer or the protective layer, is increased. The adjustment is preferably effected by a surface treatment. A preferred surface treatment is one selected from the group consisting of a plasma treatment, a corona treatment and a flame treatment, or a combination of at least two of these. Further preferably, the aforementioned surface treatment is effected, more preferably in the case of the plasma treatment, in a vacuum. A contribution to the achievement of at least one of the objects of the invention is made by an embodiment 1 of a sheetlike composite 2 obtainable by the method 1 according to any of its embodiments 1 to 24.

A contribution to the achievement of at least one of the objects of the invention is made by an embodiment 1 of a container precursor 1 including at least one sheetlike region of the sheetlike composite 1 or 2, in each case according to any of its embodiments.

In one embodiment 2 according to the invention, the container precursor 1 is configured according to its embodiment 1, wherein the sheetlike composite comprises at least 2, more preferably at least 4, folds.

In one embodiment 3 according to the invention, the container precursor 1 is configured according to its embodiment 1 or 2, wherein the sheetlike composite comprises a first longitudinal edge and a further longitudinal edge, wherein the first longitudinal edge is joined to the further longitudinal edge, thereby forming a longitudinal seam of the container precursor.

A contribution to the achievement of at least one of the objects of the invention is made by an embodiment 1 of a closed container 1 including at least one sheetlike region of the sheetlike composite 1 or 2, in each case according to any of its embodiments.

In one embodiment 2 according to the invention, the closed container 1 is configured according to its embodiment 1, wherein the sheetlike composite comprises a first longitudinal edge and a further longitudinal edge, wherein the first longitudinal edge is joined to the further longitudinal edge, thereby forming a longitudinal seam of the closed container.

In one embodiment 3 according to the invention, the closed container 1 is configured according to its embodiment 1 or 2, wherein the closed container comprises a food or drink product.

In one embodiment 4 according to the invention, the closed container 1 is configured according to any of its embodiments 1 to 3, wherein the closed container at least partly surrounds an internal volume in the range from 20 to 2000 ml, preferably from 30 to 1500 ml, more preferably from 40 to 1000 ml.

A contribution to the achievement of at least one of the objects of the invention is made by an embodiment 1 of a method 2 comprising, as method steps,
A. providing at least one sheetlike region of the sheetlike composite 1 or 2, in each case according to its embodiments, in each case including a first longitudinal edge and a further longitudinal edge;
B. folding the at least one sheetlike region; and
C. contacting and joining the first longitudinal edge to the further longitudinal edge, thereby obtaining a longitudinal seam.

A contribution to the achievement of at least one of the objects of the invention is made by an embodiment 1 of a container precursor 2, obtainable by the method 2 according to its embodiment 1.

A contribution to the achievement of at least one of the objects of the invention is made by an embodiment 1 of a method 3 comprising, as method steps,
A) providing the container precursor 1 or 2, in each case according to any of its embodiments;
B) forming a base region of the container precursor by folding the sheetlike composite;
C) closing the base region;
D) filling the container precursor with a food or drink product, and
E) closing the container precursor in a top region, thereby obtaining a closed container.

The method 3 is preferably a method of producing a closed container. A preferred closed container is a food or drink product container. The closing in the method step C) preferably comprises a sealing, more preferably a hot air sealing. The closing in the method step E) preferably comprises a sealing, more preferably an ultrasound sealing.

In one embodiment 2 according to the invention, the method 3 is configured according to its embodiment 1, wherein the method further comprises a method step of
F) joining the closed container to an opening aid.

A contribution to the achievement of at least one of the objects of the invention is made by an embodiment 1 of a closed container 2 obtainable by the method 3 according to its embodiment 1 or 2.

A contribution to the achievement of at least one of the objects of the invention is made by an embodiment 1 of a use 1 of an adhesion promoter composition A having a first acrylate content and an adhesion promoter composition B having a further acrylate content for production of a sheetlike composite for a food or drink product container, wherein the sheetlike composite includes a barrier layer, wherein, in the sheetlike composite,
a) a first adhesion promoter layer obtainable from the adhesion promoter composition A overlays the barrier layer on a first side, and
b) a further adhesion promoter layer obtainable from the adhesion promoter composition B overlays the barrier layer on a side opposite the first side,

wherein the first acrylate content and the further acrylate content are each in a range from 7% to 40% by weight, preferably from 8% to 40% by weight, more preferably from 9% to 40% by weight, more preferably from 10% to 40% by weight, even more preferably from 11% to 40% by weight, even more preferably from 12% to 35% by weight, most preferably from 13% to 30% by weight, based in each case on the weight of the respective adhesion promoter composition. Preferably, the first adhesion promoter layer or the further adhesion promoter layer or each of them adjoins the barrier layer. The barrier layer is preferably configured according to any of the embodiments of the sheetlike composite 1 of the invention. Preferably, the sheetlike composite comprises, as mutually superposed layers in a direction from an outer face of the sheetlike composite to an inner face of the sheetlike composite,
a) a carrier layer,
b) the first adhesion promoter layer,
c) a barrier layer,
d) the further adhesion promoter layer, and
e) an inner polymer layer.

Preferably, the adhesion promoter composition A includes an adhesion promoter polymer A. Additionally or alternatively, the adhesion promoter composition B preferably includes an adhesion promoter polymer B. Preferably, the adhesion promoter polymer A is configured according to any of the embodiments of the sheetlike composite 1 of the invention. Additionally or alternatively, the adhesion promoter polymer B is preferably configured according to any of the embodiments of the sheetlike composite 1 of the invention. Preferably, the adhesion promoter composition A or the adhesion promoter composition B or each of them is configured according to an embodiment of the method 1 of the invention. Preferably, the sheetlike composite is configured according to any of the embodiments of the sheetlike composite 1 of the invention. Preferably, the first adhesion promoter layer is configured according to any of the embodiments of the sheetlike composite 1 of the invention. Additionally or alternatively, the further adhesion promoter layer is preferably configured according to any of the embodiments of the sheetlike composite 1 of the invention. One embodiment of the invention relates to a use of an adhesion promoter in a first adhesion promoter layer of a sheetlike composite and of the same adhesion promoter in a further adhesion promoter layer of the sheetlike composite, wherein the sheetlike composite comprises, as mutually superposed layers in a direction from an outer face of the sheetlike composite to an inner face of the sheetlike composite,
a) a carrier layer,
b) the first adhesion promoter layer,
c) a barrier layer,
d) the further adhesion promoter layer, and
e) a first inner polymer layer.

A contribution to the achievement of at least one of the objects of the invention is made by an embodiment 1 of a use 2 of the sheetlike composite 1 or 2, in each case according to any of its embodiments, for production of a food or drink product container.

A contribution to the achievement of at least one of the objects of the invention is made by an embodiment 1 of a use 3 of at least one sheetlike region of the sheetlike composite 1 or 2, in each case according to any of its embodiments, in a microwave oven. In this case, the at least one sheetlike region of the sheetlike composite, preferably a blank of the sheetlike composite, is encompassed by a container which in turn comprises a food or drink product which is to be heated by irradiation with microwaves in the microwave oven.

Features which are described as preferred in one category of the invention, for example for the sheetlike composite 1, are likewise preferred in an embodiment of the further categories of the invention, for example an embodiment of the method 1 of the invention.

Adhesion/Adhesion Promoter Layer

An adhesion promoter layer is a layer of the sheetlike composite including at least one adhesion promoter in a sufficient amount, so that the adhesion promoter layer improves adhesion between the layers adjoining the adhesion promoter layer. For this purpose, the adhesion promoter layer preferably includes an adhesion promoter polymer. Accordingly, the adhesion promoter layers are preferably polymer layers. The first adhesion promoter layer preferably includes an adhesion promoter polymer A and the further adhesion promoter layer an adhesion promoter polymer B. In a preferred embodiment, the first adhesion promoter layer includes the adhesion promoter polymer A at a proportion in a range from 30% to 100% by weight, preferably from 40% to 100% by weight, more preferably from 50% to 100% by weight, more preferably from 60% to 100% by weight, more preferably from 70% to 100% by weight, more preferably from 80% to 100% by weight, most preferably from 90% to 100% by weight, based in each case on the weight of the first adhesion promoter layer. Additionally or alternatively, the further adhesion promoter layer includes the adhesion promoter polymer B at a proportion in a range from 30% to 100% by weight, preferably from 40% to 100% by weight, more preferably from 50% to 100% by weight, more preferably from 60% to 100% by weight, more preferably from 70% to 100% by weight, more preferably from 80% to 100% by weight, most preferably from 90% to 100% by weight, based in each case on the weight of the further adhesion promoter layer. Preferably, the first adhesion promoter layer consists of the adhesion promoter polymer A. Additionally or alternatively, the further adhesion promoter layer preferably consists of the adhesion promoter polymer B. Useful adhesion promoter polymers in an adhesion promoter layer, especially in the first adhesion promoter layer and in the further adhesion promoter layer, i.e. very particularly as adhesion promoter polymer A and as adhesion promoter polymer B, include all polymers which are suitable for producing a firm bond through functionalization by means of suitable functional groups, through the forming of ionic bonds or covalent bonds with a surface of a respective adjacent layer. They are preferably functionalized polyolefins. The adhesion promoter polymer A and the adhesion promoter polymer B are preferably terpolymers. A terpolymer here is a polymer which is prepared by polymerization of three different monomers. Terpolymers are prepared, for example, by grafting of a further monomer onto a dimer composed of two different monomers (graft copolymerization), bulk polymerization or else random copolymerization of three monomers. In this case, the adhesion promoter polymer A and the adhesion promoter polymer B may be the same or different terpolymers. Preferably, the adhesion promoter polymer A and the adhesion promoter polymer B are the same terpolymer.

Between layers of the sheetlike composite, none of which is an adhesion promoter layer and which need not necessarily adjoin one another, there may also be an adhesion promoter layer of the sheetlike composite which is additional to the first and further adhesion promoter layers. Preferred functionalized polyolefins for such additional adhesion promoter layers are acrylic acid copolymers which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel®0609HSA trade names by DuPont or the Escor®6000ExCo trade name by ExxonMobil Chemicals.

According to the invention, it is preferable that the adhesion between a carrier layer, a polymer layer or a barrier layer and the next layer in each case is at least 0.5 N/15 mm, preferably at least 0.7 N/15 mm and especially preferably at least 0.8 N/15 mm. In one configuration according to the invention, it is preferable that the adhesion between a polymer layer and a carrier layer is at least 0.3 N/15 mm, preferably at least 0.5 N/15 mm and especially preferably at least 0.7 N/15 mm. It is further preferable that the adhesion between a barrier layer and a polymer layer is at least 0.8 N/15 mm, preferably at least 1.0 N/15 mm and especially preferably at least 1.4 N/15 mm. If a barrier layer indirectly follows a polymer layer with an adhesion promoter layer in between, it is preferable that the adhesion between the barrier layer and the adhesion promoter layer is at least 1.8 N/15 mm, preferably at least 2.2 N/15 mm and especially preferably at least 2.8 N/15 mm. In a particular configuration, the adhesion between the individual layers is sufficiently strong that a carrier layer is torn apart in the adhesion test, called a cardboard fibre tear in the case of a cardboard as the carrier layer.

Barrier Layer

The barrier layer preferably has sufficient barrier action against oxygen or water vapour or both. Accordingly, the barrier layer is preferably an oxygen barrier layer or a water vapour barrier layer or both. An oxygen barrier layer has a barrier effect against permeation of oxygen. A water vapour barrier layer has a barrier effect against permeation of water vapour. In principle, the barrier layer, for this purpose, may include one selected from the group consisting of a polymer barrier layer, a metal layer and oxide layer, or a combination of at least two of the above. The oxide layer here may be a metal oxide layer, for example an aluminium oxide layer, a semimetal oxide layer, for example a silicon oxide layer, or else a non-metal oxide layer. A preferred metal layer is an aluminium layer.

If the barrier layer is a polymer barrier layer, this preferably includes at least 70% by weight, especially preferably at least 80% by weight and most preferably at least 95% by weight of at least one polymer which is known to the person skilled in the art for this purpose, especially for aroma or gas barrier properties suitable for packaging containers. Useful polymers, especially thermoplastics, here include N- or O-bearing polymers, either alone or in mixtures of two or more. According to the invention, it may be found to be advantageous when the polymer barrier layer has a melting temperature in a range from more than 155 to 300° C., preferably in a range from 160 to 280° C. and especially preferably in a range from 170 to 270° C. Further preferably, the polymer barrier layer has a basis weight in a range from 2 to 120 g/m², preferably in a range from 3 to 60 g/m², especially preferably in a range from 4 to 40 g/m² and further preferably from 6 to 30 g/m². Further preferably, the polymer barrier layer is obtainable from melts, for example by extrusion, especially laminar extrusion. Further preferably, the polymer barrier layer may also be introduced into the sheetlike composite via lamination. It is preferable in this context that a film is incorporated into the sheetlike composite. In another embodiment, it is also possible to select polymer barrier layers obtainable by deposition from a solution or dispersion of polymers. Suitable polymers preferably include those having a weight-average molecular weight, determined by gel permeation chromatography (GPC) by means of light scattering, in a range from 3·10³ to 1·10⁷ g/mol, preferably in a range from 5·10³ to 1·10⁶ g/mol and especially preferably in a range from 6·10³ to 1·10⁵ g/mol. Suitable polymers especially include polyamide (PA) or polyethylene vinyl alcohol (EVOH) or a mixture thereof. Among the polyamides, useful PAs are all of those that seem suitable to the person skilled in the art for the use according to the invention. Particular mention should be made here of PA 6, PA 6.6, PA 6.10, PA 6.12, PA 11 or PA 12 or a mixture of at least two of these, particular preference being given to PA 6 and PA 6.6 and further preference to PA 6. PA 6 is commercially available, for example, under the Akulon®, Durethan® and Ultramid® trade names. Additionally suitable are amorphous polyamides, for example MXD6, Grivory® and Selar® PA. It is further preferable that the PA has a density in a range from 1.01 to 1.40 g/cm³, preferably in a range from 1.05 to 1.30 g/cm³ and especially preferably in a range from 1.08 to 1.25 g/cm³. It is further preferable that the PA has a viscosity number in a range from 130 to 250 ml/g and preferably in a range from 140 to 220 ml/g. Useful EVOHs include all the EVOHs that seem suitable to the person skilled in the art for the use according to the invention. Examples of these are commercially available, inter alia, under the EVAL™ trade names from EVAL Europe NV, Belgium, in a multitude of different versions, for example the EVAL™ F104B or EVAL™ LR171B types.

More preferably in the context of the invention, the barrier layer includes, as mutually superposed layers, a barrier substrate layer and a barrier material layer. In a preferred configuration, the barrier layer further includes a protective layer on a side of the barrier material layer remote from the barrier substrate layer. This protective layer serves primarily to protect the barrier material layer from mechanical influences. The protective layer is frequently also referred to as a top coating or protective lacquer, although it need not necessarily be a lacquer by definition. The aforementioned preferred barrier layers with a barrier substrate layer and barrier material layer are commercially available as barrier films, for example from Toppan Printing Co. Ltd. According to the invention, it may be found to be advantageous when the barrier substrate layer or the barrier material layer or each of them has a melting temperature in a range from more than 155 to 300° C., preferably in a range from 160 to 280° C. and especially preferably in a range from 170 to 270° C. Further preferably, the barrier layer may also be introduced into the sheetlike composite via lamination.

Barrier Substrate Layer

The barrier substrate layer may consist of any material that seems suitable to the person skilled in the art for use as a barrier substrate layer of the invention. In this context, the barrier substrate layer is preferably suitable for being coated with a barrier material to give an inventive thickness of the barrier material layer. Preferably, the layer surface is formed with sufficient smoothness for this purpose. Further preferably, the barrier substrate layer has a thickness in a range from 3 to 30 μm, preferably from 2 to 28 μm, more preferably from 2 to 26 μm, more preferably from 3 to 24 μm, more preferably from 4 to 22 μm, most preferably from 5 to 20 μm. Further, the barrier substrate layer preferably has a barrier effect against oxygen or water vapour or both. Preferably, a barrier effect of the barrier material layer against permeation of oxygen is greater than a barrier effect of the barrier substrate layer against permeation of oxygen. Preferably, the barrier substrate layer has an oxygen permeation rate in a range from 0.1 to 50 cm³/(m²·d·bar), preferably from 0.2 to 40 cm³/(m²·d·bar), more preferably from 0.3 to 30 cm³/(m²·d·bar). A preferred barrier substrate layer includes, more preferably consists of, cellulose or a polymer or both. A preferred polymer here is an oriented polymer. The oriented polymer has preferably been monoaxially oriented or biaxially oriented. A further preferred polymer is a thermoplastic polymer. Preferably, the barrier substrate layer consists of the polymer.

Preferably, the barrier substrate layer includes a polymer selected from the group consisting of a polycondensate, a polyethylene, a polypropylene, a polyvinyl alcohol, or a combination of at least two of these, at a proportion of at least 50% by weight, preferably of at least 60% by weight, more preferably of at least 70% by weight, more preferably of at least 80% by weight, most preferably of at least 90% by weight, based in each case on the weight of the barrier substrate layer. More preferably, the barrier substrate layer consists of the aforementioned polymer. A preferred polypropylene has been oriented, especially longitudinally stretched (oPP) or biaxially stretched (BoPP). A preferred polycondensate is a polyester or polyamide (PA) or both. A preferred polyester is one selected from the group consisting of a polyethylene terephthalate (PET), a polylactide (PLA) and a combination of at least two of these. A preferred polyvinyl alcohol is a vinyl alcohol copolymer. A preferred vinyl alcohol copolymer is an ethylene-vinyl alcohol copolymer (EVOH).

Among the polyamides, useful PAs are all of those that seem suitable to the person skilled in the art for the use according to the invention. Particular mention should be made here of PA 6, PA 6.6, PA 6.10, PA 6.12, PA 11 or PA 12 or a mixture of at least two of these, particular preference being given to PA 6 and PA 6.6 and further preference to PA 6. PA 6 is commercially available, for example, under the Akulon®, Durethan® and Ultramid® trade names. Additionally suitable are amorphous polyamides, for example MXD6, Grivory® and Selar® PA. It is further preferable that the PA has a density in a range from 1.01 to 1.40 g/cm³, preferably in a range from 1.05 to 1.30 g/cm³ and especially preferably in a range from 1.08 to 1.25 g/cm³. It is further preferable that the PA has a viscosity number in a range from 130 to 250 ml/g and preferably in a range from 140 to 220 ml/g.

Useful EVOHs include all the EVOHs that seem suitable to the person skilled in the art for the use according to the invention. Examples of these are commercially available, inter alia, under the EVAL™ trade names from EVAL Europe NV, Belgium, in a multitude of different versions, for example the EVAL™ F104B or EVAL™ L171B types. Preferred EVOHs have at least one, two, more than two or all of the following properties:
an ethylene content in a range from 20 to 60 mol %, preferably from 24 to 45 mol %;
a density in a range from 1.0 to 1.4 g/cm³, preferably from 1.1 to 1.3 g/cm³;
a melting point in a range from more than 155 to 235° C., preferably from 165 to 225° C.;
an MFR value (210° C./2.16 kg when T_{m(EVOH)}<230° C.; 230° C./2.16 kg when 210° C.<T_{m(EVOH)}<230° C.) in a range from 1 to 25 g/10 min, preferably from 2 to 20 g/10 min;
an oxygen permeation rate in a range from 0.05 to 3.2 cm³·20 μm/m²·d·bar, preferably in a range from 0.1 to 2.5 cm³·20 μm/m²·d·bar.

Preferably at least one polymer layer, further preferably the inner polymer layer, or preferably all polymer layers, has/have a melting temperature below the melting temperature of the barrier substrate layer or of the barrier material layer or both. This is especially true when the barrier substrate layer is formed from polymer. In this case, the melting temperatures of the at least one polymer layer, especially the inner polymer layer, and the melting temperature of the barrier substrate layer or of the barrier material layer or both differ preferably by at least 1 K, especially preferably by at least 10 K, even more preferably by at least 50 K, further preferably at least 100 K. The temperature difference should preferably be chosen only such that it is sufficiently high that there is no melting of the barrier substrate layer or of the barrier material layer or both during the folding.

Barrier Material Layer

The barrier material layer used may be any material which is suitable for a person skilled in the art for this purpose and which has sufficient barrier action, especially with respect to oxygen or water vapour or both. In a preferred embodiment, the barrier material layer may take the form of a foil or of a deposited layer. A deposited barrier material layer is produced by way of example by vapour deposition of the barrier material on the barrier substrate layer. A preferred method for this purpose is the physical gas phase deposition (PVD—physical vapour deposition) or the, preferably plasma-assisted, chemical gas phase deposition (CVD—chemical vapour deposition). The barrier material layer is preferably an uninterrupted layer.

Layers of the Sheetlike Composite

The layers of the layer sequence have been joined to one another. Two layers have been joined to one another when their adhesion to one another extends beyond van der Waals attraction forces. Layers that have been joined to one another preferably belong to a category selected from the group consisting of sealed to one another, adhesively bonded to one another and compressed to one another, or a combination of at least two of these. Unless stated otherwise, in a layer sequence, the layers may follow one another indirectly, i.e. with one or at least two intermediate layers, or directly, i.e. with no intermediate layer. This is the case especially in the form of words in which one layer overlays another layer. A form of words in which a layer sequence comprises enumerated layers means that at least the layers specified are present in the sequence specified. This form of words does not necessarily mean that these layers follow on directly from one another. A form of words in which two layers adjoin one another means that these two layers follow on from one another directly and hence with no intermediate layer. However, this form of words does not specify whether or not the two layers have been joined to one another. Instead, these two layers may be in contact with one another. Preferably, however, these two layers are joined to one another.

Polymer Layers

The term “polymer layer” refers hereinafter especially to the inner polymer layer, the polymer interlayer and the outer polymer layer. A preferred polymer is a polyolefin. The polymer layers may have further constituents. The polymer layers are preferably introduced into or applied to the sheetlike composite material in an extrusion method. The further constituents of the polymer layers are preferably constituents that do not adversely affect the behaviour of the polymer melt on application as a layer. The further constituents may, for example, be inorganic compounds, such as metal salts, or further polymers, such as further thermoplastics. However, it is also conceivable that the further constituents are fillers or pigments, for example carbon black or metal oxides. Suitable thermoplastics for the further constituents especially include those that are readily processible by virtue of good extrusion characteristics. Among these, polymers obtained by chain polymerization are suitable, especially polyesters or polyolefins, particular preference being given to cyclic olefin copolymers (COCs), polycyclic olefin copolymers (POCs), especially polyethylene and polypropylene, and very particular preference to polyethylene. Among the polyethylenes, preference is given to HDPE (high density polyethylene), MDPE (medium density polyethylene), LDPE (low density polyethylene), LLDPE (linear low density polyethylene) and VLDPE (very low density polyethylene) and mixtures of at least two of these. It is also possible to use mixtures of at least two thermoplastics. Suitable polymer layers have a melt flow rate (MFR) in a range from 1 to 25 g/10 min, preferably in a range from 2 to 20 g/10 min and more preferably in a range from 2.5 to 15 g/10 min, and a density in a range from 0.890 g/cm³ to 0.980 g/cm³, preferably in a range from 0.895 g/cm³ to 0.975 g/cm³, and further preferably in a range from 0.900 g/cm³ to 0.970 g/cm³. The polymer layers preferably have at least one melting temperature in a range from 80 to 155° C., preferably in a range from 90 to 145° C. and more preferably in a range from 95 to 135° C.

Inner Polymer Layer

The inner polymer layer is based on thermoplastic polymers, where the inner polymer layer may include a particulate inorganic solid. However, it is preferable that the inner polymer layer comprises one or more thermoplastic polymers to an extent of at least 70% by weight, preferably at least 80% by weight and more preferably at least 95% by weight, based in each case on the total weight of the inner polymer layer. Preferably, the polymer or polymer mixture of the inner polymer layer has a density (to ISO 1183-1:2004) in a range from 0.900 to 0.980 g/cm³, particularly preferable in a range from 0.900 to 0.960 g/cm³ and most preferably in a range from 0.900 to 0.940 g/cm³. The polymer is preferably a polyolefin, mPolymer or a combination of the two. The inner polymer layer preferably comprises a polyethylene or a polypropylene or both. In this context, a particularly preferred polyethylene is an LDPE. Preferably, the inner polymer layer includes the polyethylene, polypropylene or both together at a proportion of at least 30% by weight, more preferably at least 40% by weight, most preferably at least 50% by weight, based in each case on the total weight of the inner polymer layer. Additionally or alternatively, the inner polymer layer preferably includes an HDPE, preferably at a proportion of at least 5% by weight, more preferably at least 10% by weight, more preferably at least 15% by weight, most preferably at least 20% by weight, based in each case on the total weight of the polymer layer. Additionally or alternatively to one or more of the aforementioned polymers, the inner polymer layer preferably includes a polymer prepared by means of a metallocene catalyst, preferably an mPE. Preferably, the inner polymer layer includes the mPE at a proportion of at least 3% by weight, more preferably at least 5% by weight, based in each case on the total weight of the inner polymer layer. In this case, the inner polymer layer may include 2 or more, preferably 2 or 3, of the aforementioned polymers in a polymer blend, for example at least a portion of the LDPE and the mPE, or at least a portion of the LDPE and the HDPE. In addition, the inner polymer layer may include 2 or more, preferably 3, mutually superposed sublayers which preferably form the inner polymer layer. The sublayers are preferably layers obtained by coextrusion.Preferably, the further adhesion promoter layer adjoins the inner polymer layer.

In a preferred configuration of the sheetlike composite, the inner polymer layer includes, in a direction from the outer face of the sheetlike composite to the inner face of the sheetlike composite, a first sublayer including an LDPE at a proportion of at least 50% by weight, preferably of at least 60% by weight, more preferably of at least 70% by weight, even more preferably of at least 80% by weight, most preferably of at least 90% by weight, based in each case on the weight of the first sublayer, and a further sublayer including a blend, wherein the blend includes an LDPE at a proportion of at least 30% by weight, preferably of at least 40% by weight, more preferably of at least 50% by weight, even more preferably of at least 60% by weight, most preferably of at least 65% by weight, and an mPE at a proportion of at least 10% by weight, preferably of at least 15% by weight, more preferably of at least 20% by weight, most preferably of at least 25% by weight, based in each case on the weight of the blend. In this case, the further sublayer includes the blend preferably at a proportion of at least 50% by weight, preferably of at least 60% by weight, more preferably of at least 70% by weight, even more preferably of at least 80% by weight, most preferably of at least 90% by weight, based in each case on the weight of the further sublayer. Particularly preferable, the further sublayer consists of the blend.

In a further preferred configuration of the sheetlike composite, the inner polymer layer includes, in a direction from the outer face of the sheetlike composite to the inner face of the sheetlike composite, a first sublayer including an HDPE at a proportion of at least 30% by weight, preferably of at least 40% by weight, more preferably of at least 50% by weight, even more preferably of at least 60% by weight, most preferably of at least 70% by weight, and an LDPE at a proportion of at least 10% by weight, preferably of at least 15% by weight, more preferably of at least 20% by weight, based in each case on the weight of the first sublayer; a second sublayer including an LDPE at a proportion of at least 50% by weight, preferably of at least 60% by weight, more preferably of at least 70% by weight, even more preferably of at least 80% by weight, most preferably of at least 90% by weight, based in each case on the weight of the second sublayer; and a third sublayer including a blend, wherein the blend includes an LDPE at a proportion of at least 30% by weight, preferably of at least 40% by weight, more preferably of at least 50% by weight, even more preferably of at least 60% by weight, most preferably of at least 65% by weight, and an mPE at a proportion of at least 10% by weight, preferably of at least 15% by weight, more preferably of at least 20% by weight, most preferably of at least 25% by weight, based in each case on the weight of the blend. In this case, the third sublayer includes the blend preferably at a proportion of at least 50% by weight, preferably of at least 60% by weight, more preferably of at least 70% by weight, even more preferably of at least 80% by weight, most preferably of at least 90% by weight, based in each case on the weight of the third sublayer. More preferably, the third sublayer consists of the blend.

Outer Polymer Layer

The outer polymer layer preferably comprises a polyethylene or a polypropylene or both. Here, preferred polyethylenes are LDPE and HDPE and mixtures of these. A preferred outer polymer layer comprises an LDPE to an extent of at least 50% by weight, preferably to an extent of at least 60% by weight, more preferably to an extent of at least 70% by weight, still more preferably to an extent of at least 80% by weight, most preferably to an extent of at least 90% by weight, based in each case on the weight of the outer polymer layer.

Polymer Interlayer

The polymer interlayer preferably adjoins the first adhesion promoter layer. The polymer interlayer preferably has a thickness in a range from 10 to 30 μm, more preferably of 12 to 28 μm. The polymer interlayer preferably comprises a polyethylene or a polypropylene or both. In this context, a particularly preferred polyethylene is an LDPE. Preferably, the polymer interlayer includes the polyethylene or the polypropylene or both together at a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. Additionally or alternatively, the polymer interlayer preferably includes an HDPE, preferably at a proportion of at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. In this context, the polymer interlayer includes the aforementioned polymers preferably in a polymer blend.

Carrier Layer

The carrier layer used may be any material which is suitable for a person skilled in the art for this purpose and which has sufficient strength and stiffness to impart stability to the container to such an extent that the container in the filled state essentially retains its shape. This is, in particular, a necessary feature of the carrier layer since the invention relates to the technical field of dimensionally stable containers. Dimensionally stable containers of this kind should in principle be distinguished from pouches and bags, which are usually produced from thin films. As well as a number of plastics, preference is given to plant-based fibrous materials, especially pulps, preferably limed, bleached and/or unbleached pulps, with paper and cardboard being especially preferred. Accordingly, a preferred carrier layer comprises a multitude of fibres. The basis weight of the carrier layer is preferably in a range from 120 to 450 g/m², especially preferably in a range from 130 to 400 g/m² and most preferably in a range from 150 to 380 g/m². A preferred cardboard generally has a single-layer or multilayer structure and may have been coated on one or both sides with one or else more than one cover layer. Furthermore, a preferred cardboard has a residual moisture content of less than 20% by weight, preferably of 2% to 15% by weight and especially preferably of 4% to 10% by weight, based on the total weight of the cardboard. An especially preferred cardboard has a multilayer structure. Further preferably, the cardboard has, on the surface facing the environment, at least one lamina, but more preferably at least two laminas, of a cover layer known to the person skilled in the art as a “coating slip”. In addition, a preferred cardboard has a Scott bond value (according to Tappi T403um) in a range from 100 to 360 J/m², preferably from 120 to 350 J/m² and especially preferably from 135 to 310 J/m². By virtue of the aforementioned ranges, it is possible to provide a composite from which it is possible to fold a container with high integrity, easily and in low tolerances.

The carrier layer is characterized by a bending resistance which can be measured with a bending tester according to ISO 2493-2:2011 at a bending angle of 15°. The bending tester used is a L&W Bending Tester code 160 from Lorentzen & Wettre, Sweden. The carrier layer preferably has a bending resistance in a first direction in a range from 80 to 550 mN. In the case of a carrier layer that comprises a multitude of fibres, the first direction is preferably a direction of orientation of the fibres. A carrier layer that comprises a multitude of fibres also preferably has a bending resistance in a second direction, perpendicular to the first direction, in a range from 20 to 300 mN. The samples used for measuring the bending resistance with the above measuring device have a width of 38 mm and a clamping length of 50 mm. A preferred sheetlike composite with the carrier layer has a bending resistance in the first direction in a range from 100 to 700 mN. Further preferably, the aforementioned sheetlike composite has a bending resistance in the second direction in a range from 50 to 500 mN. The samples of the sheetlike composite used for measuring with the above measuring device also have a width of 38 mm and a clamping length of 50 mm.

Outer Face

The outer face of the sheetlike composite is a surface of a ply of the sheetlike composite which is intended to be in contact with the environment of the container in a container to be produced from the sheetlike composite. This does not contradict with the outer faces of various regions of the composite being folded onto one another and joined to one another, for example sealed to one another, in individual regions of the container.

Inner Face

The inner face of the sheetlike composite is a surface of a ply of the sheetlike composite which is intended to be in contact with the contents of the container, preferably a food or drink product, in a container to be produced from the sheetlike composite.

Polyolefin

A preferred polyolefin is a polyethylene (PE) or a polypropylene (PP) or both. A preferred polyethylene is one selected from the group consisting of an LDPE, an LLDPE, and an HDPE, or a combination of at least two of these. A further preferred polyolefin is an mPolyolefin (polyolefin prepared by means of a metallocene catalyst). Suitable polyethylenes have a melt flow rate (MFR=MFI—melt flow index) in a range from 1 to 25 g/10 min, preferably in a range from 2 to 20 g/10 min and especially preferably in a range from 2.5 to 15 g/10 min, and a density in a range from 0.910 g/cm³ to 0.935 g/cm³, preferably in a range from 0.912 g/cm³ to 0.932 g/cm³, and further preferably in a range from 0.915 g/cm³ to 0.930 g/cm³.

mPolymer

An mPolymer is a polymer which has been prepared by means of a metallocene catalyst. A metallocene is an organometallic compound in which a central metal atom is arranged between two organic ligands, for example cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two of these.

Melting Temperatures

A preferred mPolyolefin is characterized by at least one first melting temperature and a second melting temperature. Preferably, the mPolyolefin is characterized by a third melting temperature in addition to the first and second melting temperature. A preferred first melting temperature is in a range from 84 to 108° C., preferably from 89 to 103° C., more preferably from 94 to 98° C. A preferred further melting temperature is in a range from 100 to 124° C., preferably from 105 to 119° C., more preferably from 110 to 114° C.

Extrusion

In the extrusion, the polymers are typically heated to temperatures of 210 to 350° C., measured at the molten polymer film beneath the exit from the extruder die. The extrusion can be effected by means of extrusion tools which are known to those skilled in the art and are commercially available, for example extruders, extruder screws, feed blocks, etc. At the end of the extruder, there is preferably an opening through which the polymer melt is pressed. The opening may have any shape that allows extrusion of the polymer melt. For example, the opening may be angular, oval or round. The opening is preferably in the form of a slot of a funnel. Once the melt layer has been applied to the substrate layer by means of the above-described method, the melt layer is left to cool down for the purpose of heat-setting, this cooling preferably being effected by quenching via contact with a surface which is kept at a temperature in a range from 5 to 50° C., especially preferably in a range from 10 to 30° C. Subsequently, at least the flanks are separated off from the surface. The separation may be carried out in any way that is familiar and appears suitable to a person skilled in the art for separating the flanks quickly, as precisely as possible and cleanly. Preferably, the separation is effected by means of a knife, laser beam or waterjet, or a combination of two or more thereof, the use of knives being especially preferable, especially a circular knife.

Lamination

According to the invention, the carrier layer can be overlaid by the barrier layer by lamination. In this case, the prefabricated carrier and barrier layers are joined with the aid of a suitable laminating agent. A preferred laminating agent comprises an intermediate polymer composition from which a polymer interlayer is preferably obtained. In addition, the preferred laminating agent preferably includes the adhesion promoter composition A from which the first adhesion promoter layer is obtained. In this case, the intermediate polymer composition or the adhesion promoter composition A or both are preferably applied by extrusion, more preferably by coextrusion.

Colourant

Useful colourants include both solid and liquid colourants that are known to the person skilled in the art and are suitable for the present invention. According to DIN 55943:2001-10, colourant is the collective term for all colouring substances, especially for dyes and pigments. A preferred colourant is a pigment. A preferred pigment is an organic pigment. Pigments that are notable in connection with the invention are especially the pigments mentioned in DIN 55943:2001-10 and those mentioned in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9). A pigment is a colourant that is preferably insoluble in the application medium. A dye is a colourant that is preferably soluble in the application medium.

Folding of the Sheetlike Composite

The folding of the sheetlike composite is preferably performed in a temperature range from 10 to 50° C., preferably in a range from 15 to 45° C. and especially preferably in a range from 20 to 40° C. This can be achieved by the sheetlike composite being at a temperature in the aforementioned ranges. It is also preferred that a folding tool, preferably together with the sheetlike composite, is at a temperature in the aforementioned range. For this purpose, the folding tool preferably does not have a heating means. Rather, the folding tool or else the sheetlike composite or both may be cooled. It is also preferred that the folding is performed at a temperature of at most 50° C., as “cold folding”, and the joining takes place at over 50° C., preferably over 80° C. and especially preferably over 120° C., as “hot sealing”. The aforementioned conditions, and especially temperatures, preferably also apply in the environment of the folding, for example in the housing of the folding tool.

“Folding” is understood here as meaning, according to the invention, an operation in which an elongated crease, forming an angle, is made in the folded sheetlike composite, preferably by means of a folding edge of a folding tool. For this purpose, often two adjoining regions of a sheetlike composite are bent increasingly towards one another. The folding produces at least two adjoining fold regions that can then be joined at least in sub-regions to form a container region. According to the invention, the joining can be performed by any measure which appears suitable to the person skilled in the art and which allows for a join that is as gas- and liquid-tight as possible. The joining can be performed by sealing or adhesive bonding or a combination of the two measures. In the case of sealing, the join is created by means of a liquid and the solidification thereof. In the case of adhesive bonding, chemical bonds form between the interfaces or surfaces of the two articles to be joined and create the join. It is often advantageous in the case of sealing or adhesive bonding to press together the faces that are to be sealed or adhesively bonded.

Joining A useful joining method is any joining method that seems suitable to the person skilled in the art for use of the invention, by means of which a sufficiently firm bond can be obtained. A preferred joining method is any selected from the group consisting of sealing, adhesive join and pressing, or a combination of at least two of these. In the case of sealing, the join is created by means of a liquid and the solidification thereof In the case of adhesive bonding, chemical bonds form between the interfaces or surfaces of the two articles to be joined and create the join. It is often advantageous in the case of sealing or adhesive bonding to press together the faces that are to be sealed or adhesively bonded. A preferred pressing method of at least two layers is a pressing of a first surface of a first of the two layers onto a second surface of the second of the two layers that faces the first surface across at least 20%, preferably at least 30%, more preferably at least 40%, more preferably at least 50%, more preferably at least 60%, more preferably at least 70%, even more preferably at least 80%, even more preferably at least 90%, most preferably at least 95%, of the first surface. A particularly preferred joining method is a sealing. A preferred sealing method comprises, as steps, a heating, a placing onto one another and a pressing, the steps preferably being effected in this sequence. Another sequence is likewise conceivable, especially the sequence of a placing onto one another, heating and pressing. A preferred heating method is a heating of a polymer layer, preferably a thermoplastic layer, more preferably a polyethylene layer or a polypropylene layer or both. A further preferred heating method is a heating of a polyethylene layer to a temperature in a range from 80 to 140° C., more preferably from 90 to 130° C., most preferably from 100 to 120° C. A further preferred heating method is a heating of a polypropylene layer to a temperature in a range from 120 to 200° C., more preferably from 130 to 180° C., most preferably from 140 to 170° C. A further preferred heating method is effected to a sealing temperature of the polymer layer. A preferred heating method can be effected by means of radiation, by means of hot gas, by means of contact with a hot solid, by means of mechanical vibrations, preferably by means of ultrasound, by convection, or by means of a combination of at least two of these measures. A particularly preferred heating method is effected by inducement of an ultrasound vibration.

Irradiation

In the case of irradiation, any type of radiation suitable to the person skilled in the art for softening the plastics of the polymer layers present comes into consideration. Preferred types of radiation are IR and UV rays, and microwaves. In the case of the IR rays that are also used for IR welding of sheetlike composites, wavelength ranges of 0.7 to 5 μm should be mentioned. In addition, it is possible to use laser beams in the wavelength range from 0.6 to less than 1.6 μm. In connection with the use of IR rays, these are generated by various suitable sources that are known to the person skilled in the art. Short-wave radiation sources in the range from 1 to 1.6 μm are preferably halogen sources. Medium-wave radiation sources in the range from >1.6 to 3.5 μm are, for example, metal foil sources. Long-wave radiation sources in the range of >3.5 μm that are frequently used are quartz sources. Lasers are being used ever more frequently. For instance, diode lasers in the wavelength range from 0.8 to 1 μm, Nd:YAG lasers at about 1 μm and CO₂ lasers at about 10.6 μm are in use. High-frequency techniques with a frequency range from 10 to 45 MHz, frequently in a power range from 0.1 to 100 kW, are also in use.

Ultrasound

In the case of ultrasound, the following treatment parameters are preferred:
P1 a frequency in a range from 5 to 100 kHz, preferably in a range from 10 to 50 kHz and more preferably in a range from 15 to 40 kHz;
P2 an amplitude in a range from 2 to 100 μm, preferably in a range from 5 to 70 μm and more preferably in a range from 10 to 50 μm;
P3 an oscillation time (being the period of time in which an oscillation body such as a sonotrode or inductor has a contact oscillation effect on the sheetlike composite) in a range from 50 to 1000 ms, preferably in a range from 100 to 600 ms and more preferably in a range from 150 to 300 ms.

In suitable selection of the radiation and oscillation conditions, it is advantageous to take account of the natural resonances of the plastic and to select frequencies close to these.

Contact with a Solid

Heating via contact with a solid can be effected, for example, by means of a heating plate or heating mould in direct contact with the sheetlike composite, which releases the heat to the sheetlike composite.

Hot Gas

The hot gas, preferably hot air, can be directed onto the sheetlike composite by means of suitable blowers, exit openings or nozzles, or a combination of these. Frequently, contact heating and the hot gas are used simultaneously. For example, a holding device for a container precursor formed from the sheetlike composite, through which hot gas flows and which is heated as a result and releases the hot gas through suitable openings, can heat the sheetlike composite through contact with the wall of the holding device and the hot gas. In addition, the container precursor can also be heated by fixing the container precursor with a container precursor holder and directing the flow from one or two or more hot gas nozzles provided in the container precursor holder onto the regions of the container precursor that are to be heated.

Food or Drink Product

In the context of the invention, the sheetlike composite and the container precursor are preferably designed for production of a food or drink product container. In addition, the closed container according to the invention is preferably a food or drink product container. Food and drink products include all kinds of food and drink known to those skilled in the art for human consumption and also animal feeds. Preferred food and drink products are liquid above 5° C., for example milk products, soups, sauces, non-carbonated drinks

Container Precursor

A container precursor is a precursor of the closed container which arises in the course of production of a closed container. In this context, the container precursor comprises the sheetlike composite preferably in the form of a blank. In this context, the sheetlike composite may be in an unfolded or folded state. A preferred container precursor has been cut to size and is designed for production of a single closed container. A preferred container precursor which has been cut to size and is designed for production of a single closed container is also referred to as a shell or sleeve. In this context, the shell or sleeve comprises the sheetlike composite in folded form. In addition, the container precursor preferably takes the form of an outer shell of a prism. A preferred prism is a cuboid. Moreover, the shell or sleeve comprises a longitudinal seam and is open in a top region and a base region. A typical container precursor which has been cut to size and is designed for production of a multitude of closed containers is often referred to as a tube.

A further preferred container precursor is open, preferably in a top region or a base region, more preferably in both. A preferred container precursor is in the form of a shell or tube or both. A further preferred container precursor comprises the sheetlike composite in such a way that the sheetlike composite has been folded at least once, preferably at least twice, more preferably at least 3 times, most preferably at least 4 times. A preferred container precursor is in one-piece form. More preferably, a base region of the container precursor is in a one-piece design with a lateral region of the container precursor.

Container

The closed container according to the invention may have a multitude of different forms, but preference is given to an essentially cuboidal structure. In addition, the full area of the container may be formed from the sheetlike composite, or it may have a two-part or multipart construction. In the case of a multipart construction, it is conceivable that, as well as the sheetlike composite, other materials are also used, for example plastic, which can be used especially in the top or base regions of the container. In this context, however, it is preferable that the container is formed from the sheetlike composite to an extent of at least 50%, especially preferably to an extent of at least 70% and further preferably to an extent of at least 90% of the area. In addition, the container may have a device for emptying the contents. This may be formed, for example, from a polymer or mixture of polymers and be attached on the outer face of the container. It is also conceivable that this device has been integrated into the container by “direct injection moulding”. In a preferred configuration, the container according to the invention has at least one edge, preferably from 4 to 22 or else more edges, especially preferably from 7 to 12 edges. Edges in the context of the present invention are understood to mean regions which arise in the folding of an area. Examples of edges include the longitudinal contact regions between two wall areas of the container in each case, also referred to as longitudinal edges herein. In the container, the container walls are preferably the areas of the container framed by the edges. Preferably, the interior of a container according to the invention comprises a food or drink product. Preferably, the closed container does not comprise any lid or base, or either, that has not been formed in one piece with the sheetlike composite. A preferred closed container comprises a food or drink product.

Hole

The at least one hole that is provided in the carrier layer according to preferred embodiments may have any shape that is known to a person skilled in the art and suitable for various closures or drinking straws. The holes often have rounded portions in plan view. Thus, the holes may be essentially circular, oval, elliptical or drop-shaped. The shape of the at least one hole in the carrier layer usually also predetermines the shape of the opening that is produced either by an openable closure which is connected to the container and through which the content of the container is dispensed from the container after opening, or by a drinking straw in the container. Consequently, the openings of the opened container often have shapes that are comparable to or even the same as the at least one hole in the carrier layer. Configurations of the sheetlike composite with a single hole primarily serve for letting out the food or drink product located in the container that is produced from the sheetlike composite. A further hole may be provided, especially for letting air into the container while the food or drink product is being let out.

In the context of covering the at least one hole of the carrier layer, it is preferred that the hole-covering layers are at least partly joined to one another, preferably to an extent of at least 30%, preferably at least 70% and especially preferably at least 90%, of the area formed by the at least one hole. It is also preferred that the hole-covering layers are joined to one another at the edges of the at least one hole and preferably lie against the edges joined to one another, in order in this way to achieve an improved leak-tightness over a join that extends across the entire area of the hole. The hole-covering layers are often joined to one another across the region that is formed by the at least one hole in the carrier layer. This leads to a good leak-tightness of the container formed from the composite, and consequently to a desired long shelf life of the food or drink products kept in the container.

Opening/Opening Aid

The opening of the container is usually brought about by at least partially destroying the hole-covering layers that cover the at least one hole. This destruction can be effected by cutting, pressing into the container or pulling out of the container. The destruction can be effected by means of an opening aid which is joined to the container and is arranged in the region of the at least one hole, usually above the at least one hole, for example also by a drinking straw which is pushed through the hole-covering layers. It is also preferred in a configuration according to the invention that an opening aid is provided in the region of the at least one hole. It is preferred here that the opening aid is provided on the surface area of the composite that represents the outer face of the container. The container also preferably comprises a closure, for example a lid, on the outer face of the container. It is in this case preferred that the closure covers the hole at least partially, preferably completely. Consequently, the closure protects the hole-covering layers, which are less robust in comparison with the regions outside the at least one hole, from damaging mechanical effects. For opening the hole-covering layers that cover the at least one hole, the closure often comprises the opening aid. Suitable as such an opening aid are for example hooks for tearing out at least part of the hole-covering layers, edges or cutting edges for cutting into the hole-covering layers or spikes for puncturing the hole-covering layers, or a combination of at least two of these. These opening aids are often mechanically coupled to a screw lid or a cap of the closure, for example by way of a hinge, so that the opening aids act on the hole-covering layers to open the closed container when the screw lid or the cap is actuated. Closure systems of this kind, comprising composite layers covering a hole, openable closures that cover this hole and have opening aids, are sometimes referred to in the specialist literature as “overcoated holes” with “applied fitments”.

### Test Methods

The following test methods were used within the context of the invention. Unless stated otherwise, the measurements were conducted at an ambient temperature of 23° C., an ambient air pressure of 100 kPa (0.986 atm) and a relative air humidity of 50%.

Separation of Individual Layers

If individual layers of a laminate—for example the barrier layer, the outer polymer layer, the inner polymer layer or the polymer interlayer—are to be examined herein, the layer to be examined is first separated from the laminate as described below. Three specimens of the sheetlike composite are cut to size. For this purpose, unless stated otherwise, unfolded and ungrooved regions of the sheetlike composite are used. Unless stated otherwise, the specimens have dimensions of 4 cm×4 cm. Should other dimensions of the layer to be examined be necessary for the examination to be conducted, sufficiently large specimens are cut out of the laminate. The specimens are introduced into an acetic acid bath (30% acetic acid solution: 30% by weight of CH₃COOH, remainder to 100% by weight H₂O) heated to 60° C. for 30 minutes. This detaches the layers from one another. If required, the layers may also be cautiously manually pulled apart here. Should the desired layer not be sufficiently readily detachable, as an alternative, new specimens are used and these are treated in an ethanol bath (99% ethanol) as described above. If residues of the carrier layer (especially in the case of a cardboard layer as carrier layer) are present on the layer to be examined (for example the outer polymer layer or the polymer interlayer), these are cautiously removed with a brush. One sample of size sufficient for the examination to be conducted (unless stated otherwise, with an area of 4 cm²) is cut out of each of the three films thus prepared. These samples are then stored at 23° C. for 4 hours and hence dried. Subsequently, the three samples can be examined. Unless stated otherwise, the result of the examination is the arithmetic mean of the results for the three samples.

MFR

MFR is measured according to standard ISO 1133-1:2012, Method A (mass determination method), unless stated otherwise at 190° C. and 2.16 kg.

Density

Density is measured according to standard ISO 1183-1:2013.

Melting Temperature

Melting temperature is determined on the basis of the DSC method ISO 11357-1, -5. The instrument is calibrated according to the manufacturer's instructions on the basis of the following measurements:
temperature of indium-onset temperature,
heat of fusion of indium,
temperature of zinc-onset temperature.

Oxygen Permeation Rate

Oxygen permeation rate is determined according to standard ASTM D3985-05 (2010). The sample to be examined, unless stated otherwise, is taken from an ungrooved and unfolded region of the laminate. In addition, the sample to be examined is tested with the side facing outward in the laminate facing the test gas. The area of the sample is 50 cm². The measurements are conducted at an ambient temperature of 23° C., an ambient air pressure of 100 kPa (0.986 atm) and a relative air humidity of 50%. The test instrument is a Ox-Tran 2/22 from Mocon, Neuwied, Germany. The measurement is conducted without compressed air compensation. For the measurements, samples at ambient temperature are used. Further settings and factors that affect the measurement—especially the rest of those listed under point 16 of the standard ASTM D3985-05 (2010)—are defined by the instrument used and the proper use and maintenance thereof according to the manufacturer's handbook.

Viscosity Number of PA

The viscosity number of PA is measured according to the standard DIN EN ISO 307 (2013) in 95% sulfuric acid.

Molecular Weight Distribution

Molecular weight distribution is measured by gel permeation chromatography by means of light scattering: ISO 16014-3/-5 (2009-09).

Moisture Content of Cardboard

The moisture content of the cardboard is measured according to the standard ISO 287:2009.

Adhesion

The adhesion of two adjacent layers is determined by fixing them in a 90° peel test instrument, for example the Instron “German rotating wheel fixture”, on a rotatable roller which rotates at 40 mm/min during the measurement. The samples had been cut beforehand into strips 15 mm wide. On one side of the sample, the laminas are detached from one another and the detached end is clamped in a tensile device directed vertically upward. A measuring instrument to determine the tensile force is attached to the tensile device. As the roller rotates, the force needed to separate the laminas from one another is measured. This force corresponds to the adhesion of the layers to one another and is reported in N/15 mm. The separation of the individual layers can be effected mechanically, for example, or by means of a controlled pretreatment, for example by soaking the sample in 30% acetic acid at 60° C. for 3 min.

Detection of Colourants

Detection of organic colourants can be conducted in accordance with the methods described in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

Water Vapour Permeation Rate

Water vapour permeation rate is determined according to standard ASTM F1249-13. The sample to be examined, unless stated otherwise, is taken from an ungrooved and unfolded region of the laminate. In addition, the sample to be examined is tested with the side facing inward in the laminate (the side facing the contents of the container) facing the elevated humidity. The measurement area of the sample is 50 cm². The measurements are conducted at an ambient temperature of 23° C., an ambient air pressure of 100 kPa (0.986 atm) and a relative air humidity of 100% on one side of the sample and of 0% on the other side of the sample. The test instrument is a Permatran—W Model 3/33 from Mocon, Neuwied, Germany. For the measurements, samples at ambient temperature are used. Further settings and factors that affect the measurement—especially the rest of those listed under point 12 of the standard ASTM F1249-13—are defined by the instrument used and the proper use and maintenance thereof according to the manufacturer's handbook.

Layer Thickness

The layer thickness of a sample having an area of 0.5 cm² was determined by means of a scanning electron microscope (SEM). For this purpose, a cross section through the layer structure to be determined was conducted manually with a blade (Leica Microtome Blades 819). The cross section was sputtered with gold (Cressington 108auto from Cressington Scientific Instruments Ltd., Watford (UK)) and then analysed by SEM (Quanta 450, FEI Deutschland GmbH, Frankfurt) under high vacuum (p<7.0·10⁻⁵ Pa). The layer thicknesses of the individual layers were ascertained with the “xT Microscope Control” software, version 6.2.11.3381, FEI Company, Frankfurt, Germany. To determine the average thickness, three samples are taken, the layer thickness in each sample is determined as described above, and the arithmetic mean is formed.

Acrylate Content

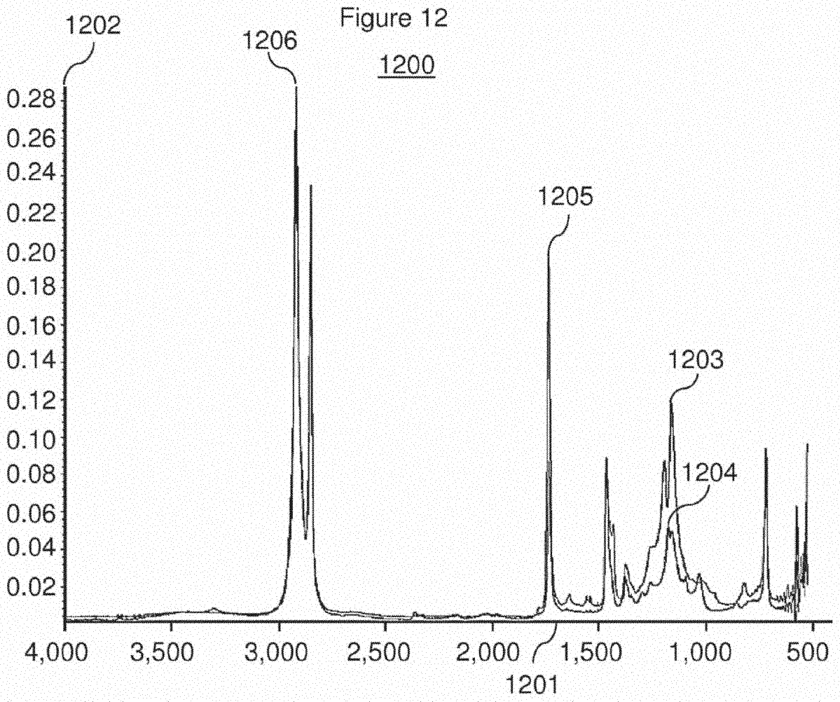

To determine the acrylate content of an adhesion promoter layer, a measurement is conducted by means of ATR infrared spectroscopy (with a Thermo Scientific Nicolet™ iN™ 10 MX Infrared Imaging Microscope from Thermo Fisher Scientific Inc.). For this purpose, the film of the adhesion promoter layer separated from the laminate as described above is placed onto the measurement surface and pressed on firmly. The film is analysed by means of Smart iTR (ATR accessory with diamond crystal). An ATR spectrum of the sample to be analysed at the above-identified position is recorded in the wavenumber range from 500 to 4000 cm⁻¹ with a resolution of 0.4 cm⁻¹ at 45° by means of a diamond as detector tip. The evaluation is effected with the aid of the OMNICTM Software 8.2. FIG. 12 described in detail below shows an example spectrum. The spectrum measured includes a maximum A of the absorption/extinction measured in the wavenumber range from 1720 to 1750 cm⁻¹. This maximum A is caused by the vibration of the acrylate component. In addition, the spectrum includes a maximum B in the wavenumber range from 2850 to 2960 cm⁻¹, which corresponds to CH valence vibration. The vibration of the acrylate component is accordingly normalized to the CH valence vibration from the same spectrum. This normalized vibration multiplied by 100 is the acrylate content to be determined in % by weight.

The measurements are calibrated using the following three adhesion promoter polymers having known acrylate contents:
Primacor 4608 (Dow, Horgen, Switzerland): acrylate content 6.5% by weight,
M21N430 (Ineos, Cologne, Germany): acrylate content 1.2% by weight, and
M28N430 (Ineos, Cologne, Germany): acrylate content 8.4% by weight.

Vicat Softening Temperature (T_{Vicat})

The Vicat softening temperature of a layer of the laminate is determined according to DIN EN ISO 306 (3/2014). For this purpose, 5 test specimens conforming to the standard of thickness 3 mm and area 10 mm×10 mm are produced from the film separated from the laminate as described above. The A50 method (force 10 N; heating rate 50 K/h) with a liquid heating bath is employed.

Tensile Strength

Tensile strength is determined according to the standard DIN EN ISO 527-3:2003-07.

Tensile Elongation

Tensile elongation is determined according to the standard JIS K 7127:1999.

Modulus of Elasticity

Modulus of elasticity is determined according to the standard DIN EN ISO 527-3:2003-07.

Surface Tension

To determine the surface tension, first of all, the contact angle for wetting with water (“water contact angle”) is determined according to the standard ASTM D5946-09. In this case, samples of dimensions 30 mm×35 mm are cut out of the laminate with a scalpel. 10 measurements are conducted on each sample, from which the mean is calculated. Prior to the measurement, the samples are prepared according to section 10.2 of the standard. The test conditions are chosen according to section 10.4. Proceeding from the measured contact angle for water, the surface tension in dyn/cm (dyn/cm=mN/m) is read off from table X2.1 of Annex X2 of the standard. The surface tension should be determined with minimum time delay after the establishment of the surface tension of the corresponding surface.

Seal Seam Strength

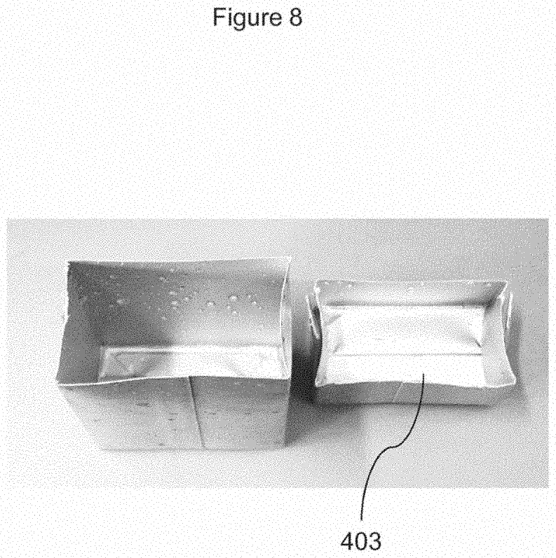

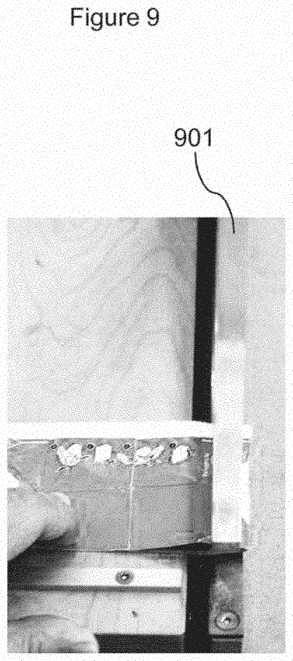

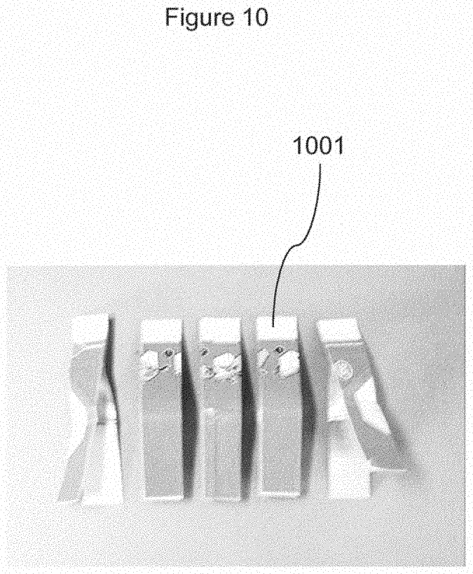

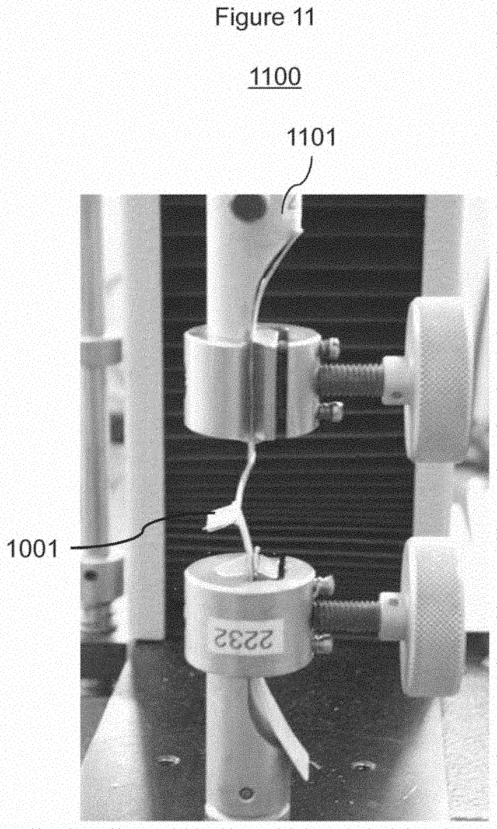

The testing means used are a safety guillotine and a TIRA test 27025 universal tensile tester from TIRA GmbH, Schalkau, Germany. For sample preparation, first of all, a scalpel is used to cut off the top region of the container. The container thus opened is emptied, cleaned with water and dried. FIG. 8 shows an opened, cleaned and emptied but as yet undried container and the cut-off top region thereof with the top seam to be examined. Without opening the top seam, the top region is folded flat and the safety guillotine is used to cut 5 samples having a length of 100 mm and a width of 15 mm out of the top region as shown in FIG. 9 for the measurement. Samples as shown in FIG. 10 are obtained. The samples are then clamped into the tensile tester (see FIG. 11). The samples are clamped into the universal tensile tester (load cell: 1 N) by the edges of length 15 mm and pulled at a speed of 40 mm/min. In the course of this, the force-distance diagram is recorded. The clamped length is 35 mm and the testing distance 15 nun. As the result of the measurement for the container, the arithmetic mean of the maximum force in the force-distance curve is formed from the 5 samples. The higher the seal seam strength, the more reliably a container is protected from unintended opening, for example during transport.

Integrity

The test medium used for integrity testing is Kristalloel 60 from Shell Chemicals with methylene blue. For this test, 250 containers made from the laminate to be examined are produced as described below for the examples and comparative examples, filled with water and closed. The closed containers are then each cut open around their circumference such that a container portion open at the top including the closed base region is obtained. This container portion is filled with about 20 ml of the test medium and stored for 24 hours. After each of one, three and 24 hours, the container portions are then inspected by the naked eye on the outside of the base region as to whether the test medium, in the case of leaking of the base region, has produced blue colours.

Microwave Oven Compatibility

The containers produced and filled as below for the examples and comparative examples are stored at ambient temperature of 23° C. for 5 hours, such that the contents of the container take on the ambient temperature. Then the closed containers are heated in a commercial microwave oven at 900 watts for 2 minutes. Thereafter, the containers are opened, the contents of the container are stirred with a wooden splint and the temperature of the contents of the container is measured with a thermometer. To assess the heating of the contents of the container, the temperature measured is compared to the ambient temperature of 23° C. For each example and comparative example, 5 identical containers are tested as above and the temperature differences attained are arithmetically averaged for the result.

Microwave compatibility is assessed by the following scale:

“−”=contents of container not heated

“+”=contents of container slightly heated

“++”=contents of container strongly heated

In addition, in the case of the containers tested that had an aluminium-containing barrier layer, after microwave heating, local damages were apparent in the top region as a result of heating.

The invention is described in more detail hereinafter by examples and drawings, although the examples and drawings do not imply any restriction of the invention. Also, unless otherwise indicated, the drawings are not to scale.

Laminate Construction

For the examples (inventive) and comparative examples (noninventive), laminates with the layer constructions and layer sequences specified in Tables 1 to 8 below were each prepared by layer extrusion methods.

### COMPARATIVE EXAMPLE 1 (NONINVENTIVE)

TABLE 1
Construction of the laminate according to Comparative Example 1

| | | Basis weight |
|---|---|---|
| Layer designation | Material | [g/m²] |
| Outer polymer layer | LDPE 23L430 from Ineos GmbH, Cologne, Germany | 15 |
| Carrier layer | Cardboard: Stora Enso Natura T Duplex | 210 |
| | double-coating-slip, Scott bond 200 | |
| | J/m², residual moisture content 7.5% | |
| Polymer interlayer | LDPE 23L430 from Ineos GmbH, Cologne, Germany | 18 |
| First | Escor 6000 HSC from Exxon Mobil | 3 |
| adhesion promoter layer | Corporation as adhesion promoter polymer A | |
| Barrier layer | Aluminium foil, EN AW 8079 from | here: thickness 9 μm |
| | Hydro Aluminium Deutschland GmbH | |
| Further | Escor 6000 HSC from Exxon Mobil | 4 |
| adhesion promoter layer | Corporation as adhesion promoter polymer B | |
| Inner polymer layer | Blend of (1) 65% by weight of LDPE | 30 |
| | 19N430 from Ineos GmbH, Cologne, | |
| | Germany and (2) 35% by weight of | |
| | Eltex 1315 AZ from Ineos GmbH, Cologne, Germany | |

### COMPARATIVE EXAMPLE 2 (NONINVENTIVE)

TABLE 2
Construction of the laminate according to Comparative Example 2

| | | Basis weight |
|---|---|---|
| Layer designation | Material | [g/m²] |
| Outer polymer layer | LDPE 23L430 from Ineos GmbH, Cologne, Germany | 15 |
| Carrier layer | Cardboard: Stora Enso Natura T Duplex | 210 |
| | double-coating-slip, Scott bond 200 | |
| | J/m², residual moisture content 7.5% | |
| First | MAH-LDPE Yparex 9207, Yparex, | 4 |
| adhesion promoter layer | Enschede, the Netherlands as adhesion | |
| | promoter polymer A | |
| Barrier layer | EVOH, available as EVAL L171B from | 5 |
| | Kuraray, Düsseldorf, Germany | |
| Further | MAH-LDPE Yparex 9207, Yparex, | 4 |
| adhesion promoter layer | Enschede, the Netherlands as adhesion | |
| | promoter polymer B | |
| Inner polymer layer | Blend of (1) 65% by weight of LDPE | 30 |
| | 19N430 from Ineos GmbH, Cologne, | |
| | Germany and (2) 35% by weight of | |
| | Eltex 1315 AZ from Ineos GmbH, Cologne, Germany | |

### COMPARATIVE EXAMPLE 3 (NONINVENTIVE)

TABLE 3
Construction of the laminate according to Comparative Example 3

| | | | Basis weight |
|---|---|---|---|
| Layer designation | | Material | [g/m²] |
| Outer polymer layer | | LDPE 23L430 from Ineos | 15 |
| | | GmbH, Cologne, Germany | |
| Carrier layer | | Cardboard: Stora Enso Natura | 210 |
| | | T Duplex double-coating-slip, | |
| | | Scott bond 200 J/m², residual | |
| | | moisture content 7.5% | |
| Polymer interlayer | | LDPE 23L430 from Ineos | 18 |
| | | GmbH, Cologne, Germany | |
| First | | Dow XZ89893 ethylene-ethyl | 2 |
| adhesion promoter layer | | acrylate copolymer from The | |
| | | Dow Chemical Company AG | |
| | | as adhesion promoter polymer | |
| | | A | |
| Barrier layer¹ | Barrier substrate layer | BOPET | |
| | Barrier material layer | Aluminium | |

Protective layer

| | | |
|---|---|---|
| Further | EAA Escor 6000 from Exxon | 3 |
| adhesion promoter layer | as adhesion promoter polymer B | |
| Inner polymer layer | Blend of (1) 65% by weight of | 30 |
| | LDPE 19N430 from Ineos | |
| | GmbH, Cologne, Germany | |
| | and (2) 35% by weight of | |
| | Eltex 1315 AZ from Ineos | |
| | GmbH, Cologne, Germany | |

(¹available as MT5000; Transparent Paper LTD, Zürich, Switzerland)

### COMPARATIVE EXAMPLE 4 (NONINVENTIVE)

TABLE 4
Construction of the laminate according to Comparative Example 4

| | | | Basis weight |
|---|---|---|---|
| Layer designation | | Material | [g/m²] |
| Outer polymer layer | | LDPE 19N430 from Ineos | 15 |
| | | GmbH, Cologne, Germany | |
| Carrier layer | | Cardboard: Stora Enso Natura | 210 |
| | | T Duplex double-coating-slip, | |
| | | Scott bond 200 J/m², residual | |
| | | moisture content 7.5% | |
| Polymer interlayer | | LDPE 19N430 from Ineos | 18 |
| | | GmbH, Cologne, Germany | |
| First | | Dow XZ89893 ethylene-ethyl | 2 |
| adhesion promoter layer | | acrylate copolymer from The | |
| | | Dow Chemical Company AG | |
| | | as adhesion promoter polymer A | |
| Barrier layer² | Barrier substrate layer | BOPET | thickness 12 μm |
| | Barrier material layer | AlOx | |

Protective layer

| | | |
|---|---|---|
| Further | EAA Escor 6000 from Exxon | 3 |
| adhesion promoter layer | as adhesion promoter polymer | |
| | B | |
| Inner polymer layer | Blend of (1) 65% by weight of | 30 |
| | LDPE 19N430 from Ineos | |
| | GmbH, Cologne, Germany | |
| | and (2) 35% by weight of | |
| | Eltex 1315 AZ from Ineos | |
| | GmbH, Cologne, Germany | |

(²available as GL-AE ▪ C-FD from Toppan Printing Co. Ltd.)

### COMPARATIVE EXAMPLE 5 (NONINVENTIVE)

TABLE 5
Construction of the laminate according to Comparative Example 5

| | | | Basis weight |
|---|---|---|---|
| Layer designation | | Material | [g/m²] |
| Outer polymer layer | | LDPE 23L430 from Ineos | 15 |
| | | GmbH, Cologne, Germany | |
| Carrier layer | | Cardboard: Stora Enso Natura | 210 |
| | | T Duplex double-coating-slip, | |
| | | Scott bond 200 J/m², residual | |
| | | moisture content 7.5% | |
| Polymer interlayer | | LDPE 23L430 from Ineos | 18 |
| | | GmbH, Cologne, Germany | |
| First | | Dow XZ89893 ethylene-ethyl | 2 |
| adhesion promoter layer | | acrylate copolymer from The | |
| | | Dow Chemical Company AG | |
| | | as adhesion promoter polymer | |
| | | A | |
| Barrier layer³ | Barrier substrate layer | BOPP | |
| | Barrier material layer | SiOx | |

Protective layer

| | | |
|---|---|---|
| Further | EAA Escor 6000 from Exxon | 3 |
| adhesion promoter layer | as adhesion promoter polymer | |
| | B | |
| Inner polymer layer | Blend of (1) 65% by weight of | 30 |
| | LDPE 19N430 from Ineos | |
| | GmbH, Cologne, Germany | |
| | and (2) 35% by weight of | |
| | Eltex 1315 AZ from Ineos | |
| | GmbH, Cologne, Germany | |

(³available as Ceramis, Amcor, Singen, Germany)

### EXAMPLE 1 (INVENTIVE)

TABLE 6
Construction of the laminate according to Example 1

| | | | Basis weight |
|---|---|---|---|
| Layer designation | | Material | [g/m²] |
| Outer polymer layer | | LDPE 23L430 from Ineos GmbH, Cologne, Germany | 15 |
| Carrier layer | | Cardboard: Stora Enso Natura T Duplex | 210 |
| | | double-coating-slip, Scott bond 200 | |
| | | J/m², residual moisture content 7.5% | |
| Polymer interlayer | | LDPE 23L430 from Ineos GmbH, Cologne, Germany | 18 |
| First | | Dow XZ89893 ethylene-ethyl acrylate | 2 |
| adhesion promoter layer | | copolymer from The Dow Chemical | |
| | | Company AG as adhesion promoter | |
| | | polymer A | |
| Barrier layer⁴ | Barrier substrate layer | BOPET | |
| | Barrier material layer | Aluminium | |

Protective layer

| | | |
|---|---|---|
| Further | Dow XZ89893 ethylene-ethyl acrylate | 3 |
| adhesion promoter layer | copolymer from The Dow Chemical | |
| | Company AG as adhesion promoter | |
| | polymer B | |
| Inner polymer layer | Blend of (1) 65% by weight of LDPE | 30 |
| | 19N430 from Ineos GmbH, Cologne, | |
| | Germany and (2) 35% by weight of | |
| | Eltex 1315 AZ from Ineos GmbH, Cologne, Germany | |

(⁴available as MT5000; Transparent Paper LTD, Zürich, Switzerland)

### EXAMPLE 2 (INVENTIVE)

TABLE 7
Construction of the laminate according to Example 2

| | | | Basis weight |
|---|---|---|---|
| Layer designation | | Material | [g/m²] |
| Outer polymer layer | | LDPE 19N430 from Ineos GmbH, | 15 |
| | | Cologne, Germany | |
| Carrier layer | | Cardboard: Stora Enso Natura T | 210 |
| | | Duplex double-coating-slip, Scott | |
| | | bond 200 J/m², residual moisture | |
| | | content 7.5% | |
| Polymer interlayer | | LDPE 19N430 from Ineos GmbH, | 18 |
| | | Cologne, Germany | |
| First | | Dow XZ89893 ethylene-ethyl | 2 |
| adhesion promoter layer | | acrylate copolymer from The | |
| | | Dow Chemical Company AG as | |
| | | adhesion promoter polymer A | |
| Barrier layer⁵ | Barrier substrate layer | BOPET | thickness 12 μm |
| | Barrier material layer | AlOx | |

Protective layer

| | | |
|---|---|---|
| Further | Dow XZ89893 ethylene-ethyl | 3 |
| adhesion promoter layer | acrylate copolymer from The | |
| | Dow Chemical Company AG as | |
| | adhesion promoter polymer B | |
| Inner polymer layer | Blend of (1) 65% by weight of | 30 |
| | LDPE 19N430 from Ineos GmbH, | |
| | Cologne, Germany and (2) 35% | |
| | by weight of Eltex 1315 AZ from | |
| | Ineos GmbH, Cologne, Germany | |

(⁵available as GL-AE ▪ C-FD from Toppan Printing Co. Ltd.)

### EXAMPLE 3 (INVENTIVE)

TABLE 8
Construction of the laminate according to Example 3

| | | | Basis weight |
|---|---|---|---|
| Layer designation | | Material | [g/m²] |
| Outer polymer layer | | LDPE 23L430 from Ineos GmbH, Cologne, Germany | 15 |
| Carrier layer | | Cardboard: Stora Enso Natura T Duplex | 210 |
| | | double-coating-slip, Scott bond 200 | |
| | | J/m², residual moisture content 7.5% | |
| Polymer interlayer | | LDPE 23L430 from Ineos GmbH, Cologne, Germany | 18 |
| First | | Dow XZ89893 ethylene-ethyl acrylate | 2 |
| adhesion promoter layer | | copolymer from The Dow Chemical | |
| | | Company AG as adhesion promoter | |
| | | polymer A | |
| Barrier layer⁶ | Barrier substrate layer | BOPP | |
| | Barrier material layer | SiOx | |

Protective layer

| | | |
|---|---|---|
| Further | Dow XZ89893 ethylene-ethyl acrylate | 3 |
| adhesion promoter layer | copolymer from The Dow Chemical | |
| | Company AG as adhesion promoter | |
| | polymer B | |
| Inner polymer layer | Blend of (1) 65% by weight of LDPE | 30 |
| | 19N430 from Ineos GmbH, Cologne, | |
| | Germany and (2) 35% by weight of | |
| | Eltex 1315 AZ from Ineos GmbH, Cologne, Germany | |

(⁶available as Ceramis, Amcor, Singen, Germany)

Laminate Production

The laminates are produced with an extrusion coating system from Davis Standard. The extrusion temperature here is in a range from about 280 to 330° C. Deviations in temperature of ±6° C. are within the normal tolerance. Deviations in the basis weights of ±3 g/m² are within the normal tolerance. In the first step, the carrier layer is provided with a hole for each container to be produced and then the outer polymer layer is applied to the carrier layer. In the second step, the barrier layer is applied together with the first adhesion promoter layer and the polymer interlayer to the carrier layer that has been coated with the outer polymer layer beforehand. In Examples 1 to 3 and in Comparative Examples 1 and 3 to 5, this second step is effected by laminating. In these examples and comparative examples, the barrier film to be laminated, immediately prior to lamination, is subjected to surface treatment on both sides in order to increase the surface tension. The surface treatment is effected with an AVE-250E instrument from AFS Entwicklungs- and Vertriebs GmbH, Germany. The input power and the voltage of the surface treatment to be conducted in the form of a corona treatment are chosen so as to give a surface tension of the barrier layer on both sides of 55 dyn/cm (=10⁻³ N/m) directly after the corona treatment. In Comparative Example 2, the second step is effected by coextrusion. Subsequently, the further adhesion promoter layer and the inner polymer layer are co-extruded onto the barrier layer. For application of the individual layers by extrusion, the polymers are melted in an extruder. In the case of application of a polymer in a layer, the resultant melt is transferred via a feed block into a nozzle and extruded onto the carrier layer. The laminates produced as described above, prior to further processing, are stored under ambient conditions (ambient temperature of 23° C., ambient air pressure of 100 kPa=0.986 atm, relative air humidity of 50%) for 3 days. The oxygen permeation rate and water vapour permeation rate are determined by the test methods described above on the ungrooved and unfolded laminates.

Container Production

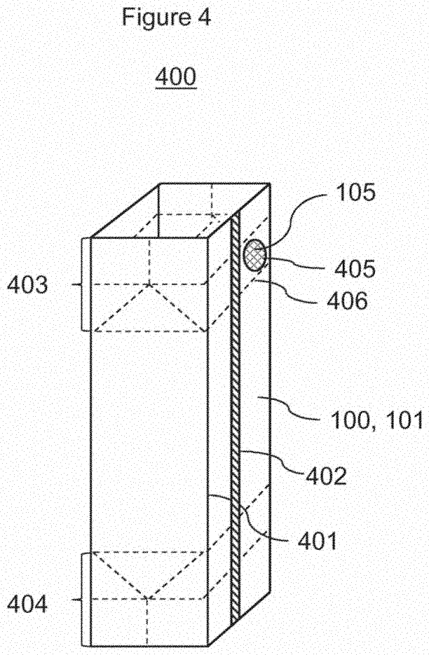

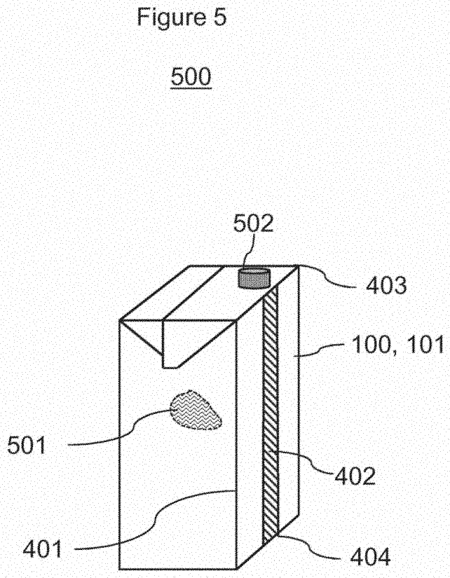

Grooves, especially longitudinal grooves, were introduced into the laminates obtained as described above on the outside (side of the outer polymer layer). In addition, the grooved laminate was divided into blanks for individual containers, each blank including one of the above holes. By folding along the 4 longitudinal grooves of each and every blank and sealing of over-lapping fold faces, a shell-shaped container precursor of the shape shown in FIG. 4 was obtained in each case. This shell was used to produce a closed container of the shape (brick type) shown in FIG. 5 in a CFA 712 standard filling machine, SIG Combibloc, Linnich. This involved producing a base region by folding and closing by heat-sealing. This gave rise to a beaker that was open at the top. The beaker was sterilized with hydrogen peroxide. In addition, the beaker was filled with water. By folding and ultrasound sealing, the top region of the beaker including the hole was closed and hence a closed container was obtained. An opening aid was secured on this container in the region of the hole.

The tests which follow were conducted on containers that were each produced from same laminates as described above. In each case by the methods as described above, laminate samples which each contain exactly one fold along a groove that runs in a straight line and right through the sample are taken, and the oxygen permeation rate and water vapour permeation rate are determined. In addition, containers were tested for the seal seam strength of the top seam (seam produced by ultrasound sealing in the top region), microwave oven compatibility and integrity, in each case by the above test methods. In addition, laminate samples were taken from containers and, by the above test methods, the acrylate contents and the Vicat softening temperatures (T_{Vicat}) of the respective first and further adhesion promoter layers were determined.

Evaluation

The results of the studies conducted in the context of the examples and comparative examples are summarized in the tables which follow.

TABLE 9
Acrylate contents of the first and further adhesion promoter layers
in the inventive examples and the noninventive comparative examples

| | Acrylate content of the first | Acrylate content of the further |
|---|---|---|
| | adhesion promoter layer | adhesion promoter layer |
| | [% by wt.] | [% by wt.] |
| Comparative | 6 | 6 |
| Example 1 | | |
| Comparative | 0.5 | 0.5 |
| Example 2 | | |
| Comparative | 10 | 6 |
| Example 3 | | |
| Comparative | 10 | 6 |
| Example 4 | | |
| Comparative | 10 | 6 |
| Example 5 | | |
| Example 1 | 10 | 10 |
| Example 2 | 10 | 10 |
| Example 3 | 10 | 10 |

TABLE 10
Vicat softening temperatures of the first and further
adhesion promoter layers in the inventive examples
and the noninventive comparative examples

| | T_{Vicat} of the first adhesion | T_{Vicat} of the further adhesion |
|---|---|---|
| | promoter layer | promoter layer |
| | [° C.] | [° C.] |
| Comparative | 86 | 86 |
| example 1 | | |
| Comparative | 93 | 93 |
| example 2 | | |
| Comparative | 53 | 86 |
| example 3 | | |
| Comparative | 53 | 86 |
| example 4 | | |
| Comparative | 53 | 86 |
| example 5 | | |
| Example 1 | 53 | 53 |
| Example 2 | 53 | 53 |
| Example 3 | 53 | 53 |

TABLE 11
Evaluation of the measurements of the oxygen and water vapour permeation rates, microwave
oven compatibility and seal seam strengths by comparison with the metal contents of
the laminates of the inventive examples and the noninventive comparative examples

| | | Oxygen permeation rate | | Water vapour permeation rate | | | |
|---|---|---|---|---|---|---|---|
| | | [cm³/(m² · d · bar)] | | [cm³/(m² · d)] | | | |
| | | before | after | before | after | | |
| | Metal content | grooving | grooving | grooving | grooving | Seal seam | Microwave oven |
| | of the laminate | and folding | and folding | and folding | and folding | strength [N] | compatibility |
| Comparative | − | 0.1 | 0.5 | 0.0 | 0.2 | 20 | − |
| Example 1 | | | | | | | |
| Comparative | +++ | 0.5 | 3.5 | 1.4 | 2.0 | 14 | ++ |
| Example 2 | | | | | | | |
| Comparative | + | 0.6 | 0.6 | 0.3 | 1.1 | 4 | − |
| Example 3 | | | | | | | |
| Comparative | ++ | 1.2 | 1.3 | 0.8 | 1.2 | 5 | + |
| Example 4 | | | | | | | |
| Comparative | +++ | 0.1 | 0.7 | 0.1 | 0.8 | 3 | ++ |
| Example 5 | | | | | | | |
| Example 1 | + | 0.6 | 0.9 | 0.3 | 1.5 | 18 | − |
| Example 2 | ++ | 1.2 | 1.3 | 0.8 | 1.0 | 21 | + |
| Example 3 | +++ | 0.1 | 0.8 | 0.1 | 0.7 | 18 | ++ |

The following scale was used for the assessment of the metal content of the above laminates:

−=very high proportion by weight of aluminium;

+=high proportion by weight of aluminium;

++=low proportion by weight of aluminium;

+++=no aluminium.

As shown by the study results summarized in Table 11, the laminates of the invention (Examples 1 to 3) are suitable for producing containers having a minimum metal content. A need for containers having a minimum metal content exists for numerous reasons. Mention should be made here, for example, of environmental reasons. For instance, metal-containing laminates are more difficult to recycle and more energy-intensive to produce. Moreover, aluminium in particular is now being regarded disadvantageous to health. Moreover, the container weight with the same contents increases with the metal content of the laminate, which leads to elevated expenditure and costs for the transport of the containers. Compared to the laminates from Comparative Examples 2 to 5 that likewise feature low metal contents, the inventive examples additionally feature the advantages which follow. Compared to Comparative Example 2, the seal seam strength and processibility of laminates have been improved in accordance with the invention. Thus, in accordance with the invention, the grooving and folding of the laminates increases the oxygen and water vapour permeation rates thereof to a minimum degree. Compared to Comparative Examples 3 to 5, the containers of the inventive examples have distinctly elevated seal seam strengths. Thus, the laminates of the invention are especially suitable for producing containers having particularly long shelf lives, even under elevated mechanical stress on the top seam, for example as a result of squeezing of the containers in the course of storage or in the course of transport. Further advantages of the laminates of the invention are described below.

TABLE 12
Evaluation of the measurements of the integrity for the inventive
examples and the noninventive comparative examples

| | Leaking | Leaking | Leaking | Leaking |
|---|---|---|---|---|
| | containers | containers | containers | containers |
| | 0 to 1 h | 1 to 3 h | 3 to 24 h | 0 to 24 h |
| Comparative | 0 | 0 | 0 | 0 |
| example 1 | | | | |
| Comparative | 0 | 0 | 3 | 3 |
| example 2 | | | | |
| Comparative | 3 | 5 | 5 | 13 |
| example 3 | | | | |
| Comparative | 5 | 4 | 6 | 15 |
| example 4 | | | | |
| Comparative | 2 | 6 | 7 | 15 |
| example 5 | | | | |
| Example 1 | 0 | 0 | 0 | 0 |
| Example 2 | 0 | 0 | 0 | 0 |
| Example 3 | 0 | 0 | 0 | 0 |

Table 12 shows that the laminates of the invention, in addition to the advantages addressed in connection with Table 11, are suitable for producing containers of high integrity. This once again underlines the suitability of the laminates according to the invention for production of containers having particularly long shelf lives. In addition, in Inventive Examples 1 to 3 (by comparison with Comparative Examples 3 to 5), the first adhesion promoter layers are made of the same material as the corresponding further adhesion promoter layers. Thus, the same adhesion promoters are used on both sides of the barrier layers. This leads to production-related advantages in the industrial scale production of such laminates. More particularly, the production plants can be configured in a simpler manner and hence with lower intensity of maintenance and at lower cost. For example, it is possible to spare one silo which provides a further adhesion promoter. Since the adhesion promoters are typically provided and stored in the form of pellets, it is also possible here to spare an additional feed to the extruder along with a suction device.

The figures respectively show, in schematic form and not to scale, unless stated otherwise in the description or the respective figure:

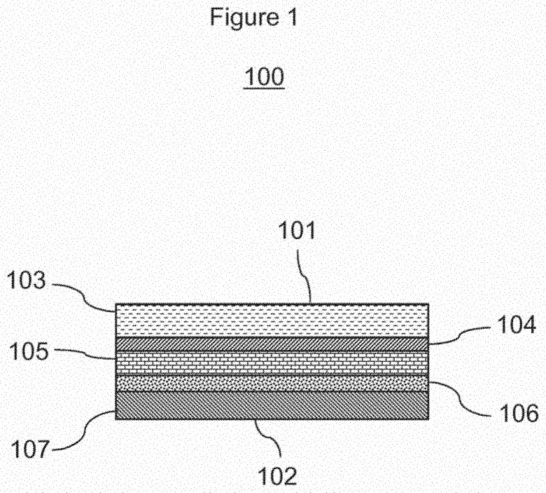

FIG. 1 a schematic diagram of a section of a sheetlike composite of the invention in cross section;

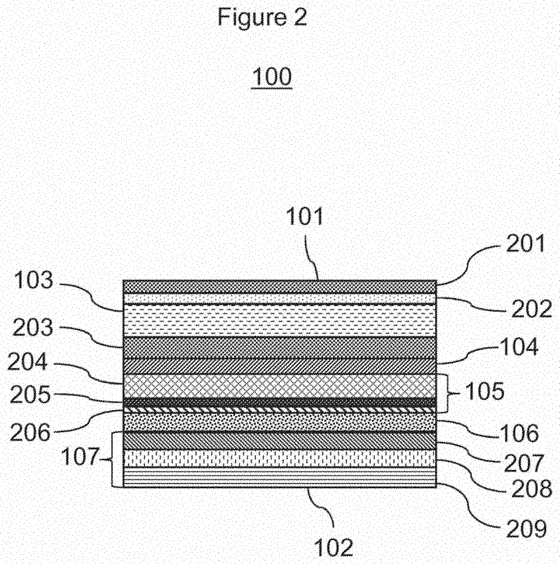

FIG. 2 a schematic diagram of a section of a further sheetlike composite according to the invention in cross section;

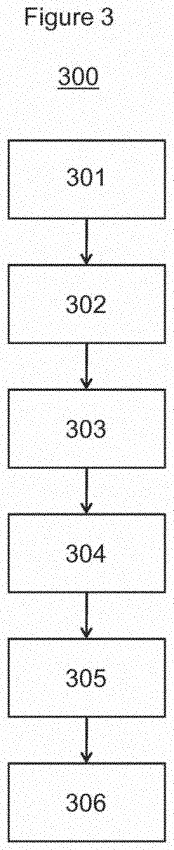

FIG. 3 a flow diagram of a method according to the invention for producing a sheetlike composite;

FIG. 4 a schematic diagram of a container precursor according to the invention;

FIG. 5 a schematic diagram of a closed container according to the invention;

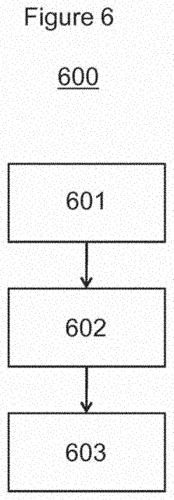

FIG. 6 a flow diagram of a method according to the invention for producing a container precursor;

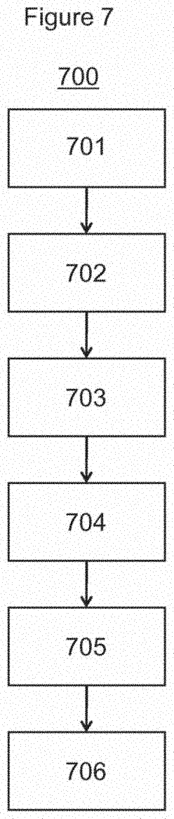

FIG. 7 a flow diagram of a method according to the invention for producing a closed container;

FIG. 8 a photograph regarding sample preparation in the “seal seam strength” test method;

FIG. 9 a photograph regarding sample preparation in the “seal seam strength” test method;

FIG. 10 a photograph of multiple samples for the “seal seam strength” test method;

FIG. 11 a photograph of the test setup for the “seal seam strength” test method; and

FIG. 12 illustrative ATR spectra regarding the “acrylate content” test method.

FIG. 1 shows a schematic diagram of a section of a sheetlike composite 100 according to the invention in cross section. The sheetlike composite 100 consists of the following layers of a layer sequence in the direction from an outer face 101 of the sheetlike composite 100 to an inner face 102 of the sheetlike composite 100: a carrier layer 103, a first adhesion promoter layer 104, a barrier layer 105, a further adhesion promoter layer 106 and an inner polymer layer 107. The carrier layer 103 is a cardboard layer identified as Stora Enso Natura T Duplex with double-coating-slip (Scott bond 200 J/m², residual moisture content 7.5%). The first adhesion promoter layer 104 and the further adhesion promoter layer 106 each consist of the adhesion promoter Lotader® 4613 from Arkema SA. The barrier layer 105 is a barrier film identified as GL-AE•C-FD from Toppan Printing Co. Ltd. In this case, in the sheetlike composite 100, the BOPET layer of the barrier film faces the outer face 101 of the sheetlike composite 100. The inner polymer layer 107 consists, in a direction from the barrier layer 105 to the inner face 102, of a sublayer consisting of LDPE 19N430 from Ineos GmbH, Cologne, Germany, and a sublayer of a blend consisting of 65% by weight of LDPE 19N430 from Ineos GmbH, Cologne, Germany and 35% by weight of Eltex 1315 AZ from Ineos GmbH, Cologne, Germany. Accordingly, the first adhesion promoter layer 104 and the further adhesion promoter layer 106 have the same acrylate content of 24% by weight, based on the weight of the respective adhesion promoter layer. The barrier layer 105 has a thickness of 12 μm.

FIG. 2 shows a schematic diagram of a section of a further sheetlike composite 100 according to the invention in cross section. The sheetlike composite 100 consists of the following layers of a layer sequence in a direction from an outer face 101 of the sheetlike composite 100 to an inner face 102 of the sheetlike composite 100: a colour application 201 which is a decoration of the sheetlike composite 100, an outer polymer layer 202, a carrier layer 103, a polymer interlayer 203, a first adhesion promoter layer 104, a barrier layer 105, a further adhesion promoter layer 106 and an inner polymer layer 107. The outer polymer layer 202 and the polymer interlayer 203 each consist of LDPE 19N430 from Ineos GmbH, Cologne, Germany. The carrier layer 103 is a cardboard layer identified as Stora Enso Natura T Duplex with double-coating-slip (Scott bond 200 J/m², residual moisture content 7.5%). The first adhesion promoter layer 104 and the further adhesion promoter layer 106 each consist of a maleic anhydride-grafted ethylene-methyl acrylate copolymer identified as Lotader 4613 from Arkema. The barrier layer 105 is a barrier film identified as GL-AE•C-FD from Toppan Printing Co. Ltd. This barrier film consists of a barrier substrate layer 204 composed of biaxially oriented PET (BOPET), an adjoining barrier material layer 205 of AlOx and an adjoining protective layer 206. In this case, in the sheetlike composite 100, the BOPET layer of the barrier film faces the outer face 101 of the sheetlike composite 100. The barrier layer 105 has a thickness of 12 μm. The inner polymer layer 107 consists, in a direction from the barrier layer 105 to the inner face 102, of the following three sublayers: a first inner layer 207 composed of 75% by weight of HDPE and 25% by weight of LDPE, based in each case on the total weight of the first inner layer 207, a second inner layer 208 composed of 100% by weight of LDPE based on the total weight of the second inner layer 208 and a third inner layer 209 composed of a polymer blend, where the polymer blend consists to an extent of 30% by weight of an mPE and to an extent of 70% by weight of an LDPE, based in each case on the total weight of the third inner layer 209. Accordingly, the first adhesion promoter layer 104 and the further adhesion promoter layer 106 consist of the same adhesion promoter polymer which has an acrylate content of 24% by weight.

FIG. 3 shows a flow diagram of a method 200 according to the invention for production of a sheetlike composite 100. The method 200 includes a method step a) 301 in which a sheetlike composite precursor is provided. For this purpose, a carrier layer 103 of cardboard is coated with an outer polymer layer 202 of LDPE. The carrier layer 103 includes a multitude of holes 405—one such hole 405 for each container 500 to be produced from the carrier layer 103. In addition, a barrier layer 105 is provided in the form of a film identified as GL-AE•C-FD from Toppan Printing Co. Ltd. Both sides of the film are prepared by a plasma treatment effected under reduced pressure so as to increase a surface tension on these two sides of the film to 65·10⁻³ N/m. In an immediately subsequent method step b) 302, the carrier layer 103 is coated on a side remote from the outer polymer layer 202, in the following sequence proceeding from the carrier layer 103, with an intermediate polymer composition of LDPE; with an adhesion promoter composition A consisting of a maleic anhydride-grafted ethylene-ethyl acrylate copolymer identified as Dow XZ89893 from The Dow Chemical Company AG as adhesion promoter polymer A; and with the barrier layer 105. In this case, the intermediate polymer composition and the adhesion promoter composition A are applied by coextrusion. A polymer interlayer 203 is obtained from the intermediate polymer composition, and a first adhesion promoter layer 104 from the adhesion promoter composition A. The barrier layer 105 has a thickness of 12 μm and its BOPET layer faces the carrier layer 103. In a method step c) 303, the barrier layer 105 is coated on a side remote from the carrier layer 103 by coextrusion, in the following sequence proceeding from the carrier layer 105, with an adhesion promoter composition B consisting of the maleic anhydride-grafted ethylene-ethyl acrylate copolymer identified as Dow XZ89893 from The Dow Chemical Company AG as adhesion promoter polymer B; and with an inner polymer layer 107. A further adhesion promoter layer 106 is obtained from the adhesion promoter composition B. The inner polymer layer 107 consists, in this sequence, in a direction proceeding from the further adhesion promoter layer 106, of a sublayer of an LDPE and a further sublayer of a blend consisting of 65% by weight of LDPE and 35% by weight of mPE, based in each case on the weight of the blend. Accordingly, in accordance with the invention, the first adhesion promoter layer 104 and the further adhesion promoter layer 106 consist of the same adhesion promoter polymer which has an acrylate content of 10% by weight. In a method step d) 304, the outer polymer layer 202 is printed on a side remote from the carrier layer 103 with a colour application 201 in the form of a decoration. The decoration includes 6 colourants of different colours and forms an outer face 101 of the sheetlike composite 100 thus obtained from the sheetlike composite precursor. In a method step e) 305, the sheetlike composite 100 obtained from the sheetlike composite precursor above is grooved. For this purpose, a grooving tool acts mechanically on the sheetlike composite 100 and produces linear depressions in the carrier layer 103, called grooves 406. In a method step f) 306, the sheetlike composite 100 is cut to size to form a multitude of blanks, in each case for production of a single closed container 500. These blanks can be processed further by the method 600 of the invention to form container precursors 400 in shell form.

FIG. 4 shows a schematic diagram of a container precursor 400 according to the invention. The container precursor 400 includes a blank of the sheetlike composite 100 obtained by the method 300 with 4 longitudinal folds 401, each of which forms a longitudinal edge 401. In the container precursor 400, the outer face 101 of the sheetlike composite 100 faces outward. The container precursor 400 is in the form of a shell and comprises a longitudinal seam 402 in which a first longitudinal edge and a further longitudinal edge of the sheetlike composite 100 are sealed to one another. In addition, the container precursor 400 comprises a hole 405 in the carrier layer 103. The hole 405 is covered by the outer polymer layer 202 (not shown), the polymer interlayer 203 (not shown), the first adhesion promoter layer 104, the barrier layer 105, the further adhesion promoter layer 106 (not shown) and the inner polymer layer 107 (not shown) as hole-covering layers. By folding along grooves 406 and joining of fold regions in a top region 403 and a base region 404 of the container precursor 400, a closed container 500 is obtainable. Such a closed container 500 is shown in FIG. 5.

FIG. 5 shows a schematic representation of a closed container 500 according to the invention. The closed container 500 has been produced from the container precursor 400 according to FIG. 4. The closed container 500 comprises a food or drink product 501 and has 12 edges. In addition, the closed container 500 is joined to a lid comprising an opening aid 502 which covers the hole 405 on the outer face 101 of the sheetlike composite 100. Here, the lid 502 comprises a cutting tool as opening aid in its interior.

FIG. 6 shows a flow diagram of a method 600 according to the invention for producing a container precursor 400. In a method step A. 601, a blank of the sheetlike composite 100 obtained as described above by the method 300 is provided. This comprises a first longitudinal edge and a further longitudinal edge. In a method step B. 602, the blank is folded. In a method step C. 603, the first longitudinal edge and the further longitudinal edge are pressed against one another and joined to one another by heat-sealing. Thus, a longitudinal seam 402 is obtained. According to the above described, the container precursor 400 according to FIG. 4 is produced.

FIG. 7 shows a flow diagram of a method 700 according to the invention for producing a closed container 500. In a method step A) 701, the container precursor 400 according to FIG. 4 is provided. In a method step B) 702, a base region 404 of the container precursor 400 is formed by folding the sheetlike composite 100. In a method step C) 703, the base region 404 is closed by sealing with hot air at a temperature of 300° C. In a method step D) 704, the container precursor 400 is filled with a food or drink product 501 and, in a method step E) 705, the container precursor 400 is closed by sealing in a top region 403, thereby obtaining the closed container 500 of FIG. 5. In a method step F) 706, the closed container 500 is joined to an opening aid 502.

FIG. 8 shows a photograph regarding the sample preparation according to the “seal seam strength” test method. What can be seen is a top region 403 separated from a closed container 500.

FIG. 9 shows a photograph regarding the sample preparation according to the “seal seam strength” test method. What can be seen is the cutting-to-size of samples 1001 with the safety guillotine 901.

FIG. 10 shows a photograph of multiple samples 1001 for the “seal seam strength” test method.

FIG. 11 shows a photograph of the test setup for the “seal seam strength” test method. What can be seen is a sample 1001 in the TIRA test 27025 tensile tester from TIRA GmbH, Schalkau, Germany (reference numeral 1101 in FIG. 11).

FIG. 12 shows illustrative ATR spectra 1200 regarding the “acrylate content” test method. The wavenumber 1201 is plotted on the abscissa axis of the diagram, and the absorption/extinction 1202 measured on the ordinate axis. What can be seen are a curve 1204 drawn in a somewhat darker colour for the adhesion promoter Dow XZ89893 from The Dow Chemical Company AG and a curve 1203 drawn in a somewhat lighter colour for the adhesion promoter Lotader® 4613 from Arkema SA. In addition, the maximum A 1205 and the maximum B 1206 are identified for the curve 1203 of the Lotader®.

### LIST OF REFERENCE SIGNS

100 Sheetlike composite according to the invention

101 Outer face

102 Inner face

103 Carrier layer

104 First adhesion promoter layer

105 Barrier layer

106 Further adhesion promoter layer

107 Inner polymer layer

201 Colour application

202 Outer polymer layer

203 Polymer interlayer

204 Barrier substrate layer

205 Barrier material layer

206 Protective layer

207 First inner layer

208 Second inner layer

209 Third inner layer

300 Method according to the invention for production of a sheetlike composite

301 Method step a)

302 Method step b)

303 Method step c)

304 Method step d)

305 Method step e)

306 Method step f)

400 Container precursor according to the invention

401 Longitudinal fold/longitudinal edge

402 Longitudinal seam

403 Top region

404 Base region

405 Hole

406 Groove

500 Closed container according to the invention

501 Food or drink product

502 Lid with opening aid

600 Method according to the invention for producing a container precursor

601 Method step A.

602 Method step B.

603 Method step C.

700 Method according to the invention for producing a closed container

701 Method step A)

702 Method step B)

703 Method step C)

704 Method step D)

705 Method step E)

706 Method step F)

901 Safety guillotine

1001 Sample for the “seal seam strength” test method

1100 Test setup for the “seal seam strength” test method

1101 TIRA test 27025 universal tensile tester

1200 Illustrative ATR spectra regarding the “acrylate content” test method

1201 Wavenumber

1202 Absorption/extinction

1203 Curve for Lotader® 4613 from Arkema SA

1204 Curve for Dow XZ89893 from The Dow Chemical Company AG

1205 Maximum A

1206 Maximum B

1. A sheetlike composite comprising, as mutually superposed layers, in a direction from an outer face of the sheetlike composite to an inner face of the sheetlike composite,
a) a carrier layer,
b) a first adhesion promoter layer having a first acrylate content,
c) a barrier layer,
d) a further adhesion promoter layer having a further acrylate content, and
e) an inner polymer layer;
wherein the first acrylate content and the further acrylate content are each in a range from 7% to 40% by weight, based on the weight of the respective adhesion promoter layer.

2. The sheetlike composite according to claim 1, wherein the first acrylate content and the further acrylate content differ from one another by not more than 10% by weight.

3. The sheetlike composite according to claim 1, wherein the first adhesion promoter layer has a first Vicat softening temperature and the further adhesion promoter layer a further Vicat softening temperature,
wherein the first Vicat softening temperature and the further Vicat softening temperature are each in a range from 20 to 120° C.

4. The sheetlike composite according to claim 1, wherein the first adhesion promoter layer includes an adhesion promoter polymer A,
wherein the further adhesion promoter layer includes an adhesion promoter polymer B.

5. The sheetlike composite according to claim 4, wherein the adhesion promoter polymer A and the adhesion promoter polymer B are polyolefin-acrylate copolymers.

6. The sheetlike composite according to claim 5, wherein the polyolefin in the adhesion promoter polymer A or the polyolefin in the adhesion promoter polymer B or each of them is based on ethylene.

7. The sheetlike composite according to claim 4, wherein the adhesion promoter polymer A or the adhesion promoter polymer B or each of them is a polyolefin-alkyl acrylate copolymer.

8. The sheetlike composite according to claim 4, wherein the adhesion promoter polymer A or the adhesion promoter polymer B or each of them is a grafted copolymer.

9. The sheetlike composite according to claim 4, wherein the adhesion promoter polymer A or the adhesion promoter polymer B or each of them is a copolymer grafted with a diacid anhydride.

10. The sheetlike composite according to claim 1, wherein the barrier layer on a side facing the carrier layer consists of a different material from that of a side facing away from the carrier layer.

11. The sheetlike composite according to claim 1, wherein the barrier layer includes, as mutually superposed sublayers,
a. a barrier substrate layer, and
b. a barrier material layer;
wherein the barrier material layer has an average thickness in a range from 1 nm to 1 μm.

12. A method comprising, as method steps:
a) providing a sheetlike composite precursor including a carrier layer;
b) overlaying the carrier layer on one side of the carrier layer in the following sequence proceeding from the carrier layer with
i) an adhesion promoter composition A having a first acrylate content, and
ii) a barrier layer; and
c) overlaying the barrier layer on a side remote from the carrier layer in the following sequence proceeding from the barrier layer with
i) an adhesion promoter composition B having a further acrylate content, and
ii) an inner polymer layer;
wherein the first acrylate content and the further acrylate content are each in a range from 7% to 40% by weight, based on the weight of the respective adhesion promoter composition.

13. A sheetlike composite obtainable by the method according to claim 12.

14. A container precursor including at least one sheetlike region of the sheetlike composite according to claim 1.

15. A closed container including at least a sheetlike region of the sheetlike composite according to claim 1.

16. A method comprising, as method steps:
A. providing at least one sheetlike region of the sheetlike composite according to claim 1, in each case including a first longitudinal edge and a further longitudinal edge;
B. folding the at least one sheetlike region; and
C. contacting and joining the first longitudinal edge to the further longitudinal edge, thereby obtaining a longitudinal seam.

17. A container precursor obtainable by the method according to claim 16.

18. A method comprising, as method steps:
A) providing the container precursor according to claim 14;
B) forming a base region of the container precursor by folding the sheetlike composite;
C) closing the base region;
D) filling the container precursor with a food or drink product, and
E) closing the container precursor in a top region, thereby obtaining a closed container.

19. A closed container obtainable by the method according to claim 18.

20. A use of an adhesion promoter composition A having a first acrylate content and an adhesion promoter composition B having a further acrylate content B for production of a sheetlike composite for a food or drink product container, wherein the sheetlike composite includes a barrier layer,
wherein, in the sheetlike composite,
a) a first adhesion promoter layer obtainable from the adhesion promoter composition A overlays the barrier layer on a first side, and
b) a further adhesion promoter layer obtainable from the adhesion promoter composition B overlays the barrier layer on a side opposite the first side,
wherein the first acrylate content and the further acrylate content are each in a range from 7% to 40% by weight, based on the weight of the respective adhesion promoter composition.

21. A use of the sheetlike composite according to claim 1 for production of a food or drink product container.

22. A use of at least one sheetlike region of the sheetlike composite according to claim 1 in a microwave oven.
